(19) United States
(12) Patent Application Publication
(10) Pub. No.: US 2026/0321863 A1
(43) Pub. Date: Oct. 15, 2026

(54) ENERGY STORAGE APPARATUS

(71) Applicant: GS Yuasa International Ltd., Kyoto-shi (JP)

(72) Inventors: Ryoichi OKUYAMA, Kyoto-shi (JP); Kazuya OKABE, Kyoto-shi (JP)

(21) Appl. No.: 19/655,983

(22) Filed: Apr. 23, 2026

Related U.S. Application Data
(63) Continuation of application No. PCT/JP2024/036792, filed on Oct. 16, 2024.

(30) Foreign Application Priority Data
Oct. 24, 2023 (JP) 2023-182727

(51) Int. Cl. H01M 50/291; H01M 10/0587; H01M 10/613; H01M 10/615; H01M 10/6556; H01M 50/103; H01M 50/209; H01M 50/293

(52) U.S. Cl. CPC H01M 50/291; H01M 10/0587; H01M 10/613; H01M 10/615; H01M 10/6556; H01M 50/103; H01M 50/209; H01M 50/293

(57) ABSTRACT

An energy storage apparatus includes an energy storage device, and a holding unit outward of the energy storage device to hold the energy storage device. The energy storage device includes an electrode assembly around which a plate is wound and a container containing the electrode assembly. The electrode assembly includes flat portions facing each other and curved portions facing each other. The container includes a flat wall facing the flat portion of the electrode assembly and a curved wall facing the curved portion of the electrode assembly. An inner surface of the flat wall has a flat shape along the flat portion. An inner surface of the holding unit includes a flat surface having a flat shape along an outer surface of the flat wall of the container and a curved surface having a curved shape along an outer surface of the curved wall of the container.

### CROSS REFERENCE TO RELATED APPLICATIONS

This application claims the benefit of priority to Japanese Patent Application No. 2023-182727 filed on Oct. 24, 2023 and is a Continuation Application of PCT Application No. PCT/JP2024/036792 filed on Oct. 16, 2024. The entire contents of each application are hereby incorporated herein by reference.

### BACKGROUND OF THE INVENTION

### 1. Field of the Invention

The present invention relates to energy storage apparatuses.

### 2. Description of the Related Art

For example, JP-A-2010-73580 discloses a nonaqueous electrolyte battery in which a wound electrode assembly is incorporated in a prismatic container.

### SUMMARY OF THE INVENTION

In the above-described conventional battery in which the wound electrode assembly is accommodated in the prismatic container, an inner wall of the container does not follow an outer surface of a curved portion of the electrode assembly since the space inside the container has a rectangular parallelepiped shape. When the electrode assembly expands with charge and discharge, the expansion of the electrode assembly easily progresses in the curved portion of the electrode assembly which is not pressed by the inner wall of the container. As a result, tensile stress (reaction force) is concentrated between the curved portion and a flat portion of the electrode assembly, which causes a defect that leads to a decrease in capacity such as deformation of the electrode assembly that may cause damage to a plate or cause lithium electrodeposition. Further, in a case where an active material that greatly expands is used, there is a possibility that significant distortion occurs, which eventually leads to foil breakage.

Example embodiments of the present invention provide energy storage apparatuses each capable of preventing deformation of an electrode assembly which may cause lithium electrodeposition even when an active material that greatly expands is used, and reducing or preventing damage to the electrode assembly.

An energy storage apparatus according to an example embodiment of the present invention includes an energy storage device, and a holding unit located outward of the energy storage device to hold the energy storage device, wherein the energy storage device includes an electrode assembly around which a plate is wound and a container which accommodates the electrode assembly, the electrode assembly has a flat shape including a pair of flat portions facing each other and a pair of curved portions facing each other, the container includes a flat wall facing the flat portion of the electrode assembly and a curved wall facing the curved portion of the electrode assembly, an inner surface of the flat wall has a flat shape along the flat portion, an inner surface of the curved wall has a curved shape along the curved portion, an inner surface of the holding unit includes a flat surface having a flat shape along an outer surface of the flat wall of the container and a curved surface having a curved shape along an outer surface of the curved wall of the container, the inner surface of the flat wall of the container presses the flat portion of the electrode assembly, the inner surface of the curved wall of the container presses the curved portion of the electrode assembly, the flat surface of the holding unit presses the outer surface of the flat wall of the container, and the curved surface of the holding unit presses the outer surface of the curved wall of the container.

According to example embodiments of the present invention, it is possible to provide energy storage apparatuses each capable of preventing deformation of an electrode assembly which may cause a lithium electrodeposition, and reducing or preventing the damage to the electrode assembly.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating an appearance of an energy storage apparatus according to an example embodiment of the present invention.

FIG. 2 is an exploded perspective view illustrating each element when an energy storage apparatus according to an example embodiment is disassembled.

FIG. 3 is a perspective view illustrating an appearance of an energy storage device according to an example embodiment of the present invention.

FIG. 4 is an exploded perspective view illustrating each element of an energy storage device according to an example embodiment in an exploded manner.

FIG. 5 is a perspective view illustrating a configuration of an electrode assembly according to an example embodiment of the present invention.

FIG. 6 is an explanatory view illustrating a holding unit, a case, and each energy storage device according to an example embodiment of the present invention.

FIG. 7 is a cross-sectional view illustrating a state in which an electrode assembly is accommodated in a prismatic container according to Comparative Example 1.

FIG. 8 is a cross-sectional view illustrating a state where an electrode assembly is accommodated in a prismatic container according to Comparative Example 2.

FIG. 9 is a cross-sectional view illustrating a positional relationship among the holding unit, the container, and the electrode assembly according to an example embodiment of the present invention.

FIG. 10 is an explanatory view illustrating a holding unit, a case, and each energy storage device according to a first modification example of an example embodiment of the present invention.

FIG. 11 is an explanatory view illustrating a holding unit, a case, and each energy storage device according to a second modification example of an example embodiment of the present invention.

FIG. 12 is a perspective view illustrating an appearance of an energy storage device according to a third modification example of an example embodiment of the present invention.

FIG. 13 is a perspective view illustrating an appearance of an energy storage device according to a fourth modification example of an example embodiment of the present invention.

FIG. 14 is a perspective view illustrating an appearance of an energy storage device according to a fifth modification example of an example embodiment of the present invention.

FIG. 15 is a perspective view illustrating an appearance of an energy storage device according to a sixth modification example of an example embodiment of the present invention.

FIG. 16 is a perspective view illustrating an appearance of an energy storage device according to a seventh modification example of an example embodiment of the present invention.

### DETAILED DESCRIPTION OF THE EXAMPLE EMBODIMENTS

The inventors have considered that a situation in which expansion in a curved portion of an electrode assembly is more likely to progress than expansion in a flat portion of the electrode assembly when a prismatic container is used and to reduce a difference in degree between ease of progress of the expansion in the curved portion of the electrode assembly and ease of progress of the expansion in the flat portion of the electrode assembly is avoided by making an inner surface of a wall (curved wall) of the container facing the curved portion of the electrode assembly follow a curved shape of the curved portion to reduce a space between the curved portion of the electrode assembly and the curved wall, and tensile stress generated at the curved portion of the electrode assembly and between the curved portion and the flat portion of the electrode assembly is reduced or prevented by bringing the container into a state of pressing the electrode assembly. Here, the inventors have studied an energy storage apparatus including a holding unit in consideration of a possibility that strength of the wall of the container cannot withstand the expansion of the curved portion of the electrode assembly, the container is deformed, and a pressing force with respect to the electrode assembly is insufficient. Then, the present inventors have discovered a configuration in which the electrode assembly is pressed via the container by providing the curved surface having a curved shape along an outer surface of the curved wall of the container on an inner surface of the holding unit so that the container is pressed by the holding unit. Accordingly, the pressing from the holding unit is transmitted to the electrode assembly via the container, a pressing force exceeding the strength of the wall of the container can be applied to the electrode assembly, and the deformation of the container due to the expansion of the electrode assembly can be reduced or prevented. As a result, tension generated at a boundary between the flat portion and the curved portion of the electrode assembly can be reduced or prevented, and a defect of the electrode assembly can be reduced or prevented.

(1) An energy storage apparatus according to an example embodiment of the present invention includes an energy storage device, and a holding unit located outward of the energy storage device to hold the energy storage device, wherein the energy storage device includes an electrode assembly around which a plate is wound and a container which accommodates the electrode assembly, the electrode assembly has a flat shape including a pair of flat portions facing each other and a pair of curved portions facing each other, the container includes a flat wall facing the flat portion of the electrode assembly and a curved wall facing the curved portion of the electrode assembly, an inner surface of the flat wall has a flat shape along the flat portion, an inner surface of the curved wall has a curved shape along the curved portion, an inner surface of the holding unit includes a flat surface having a flat shape along an outer surface of the flat wall of the container and a curved surface having a curved shape along an outer surface of the curved wall of the container, the inner surface of the flat wall of the container presses the flat portion of the electrode assembly, the inner surface of the curved wall of the container presses the curved portion of the electrode assembly, the flat surface of the holding unit presses the outer surface of the flat wall of the container, and the curved surface of the holding unit presses the outer surface of the curved wall of the container.

In an energy storage apparatus according to an example embodiment of the present invention, the container includes the flat wall facing the flat portion of the electrode assembly and the curved wall facing the curved portion of the electrode assembly, and the inner surface of the flat wall, which has the flat shape along the flat portion of the electrode assembly, presses the flat portion of the electrode assembly, and the inner surface of the curved wall, which has the curved shape along the curved portion of the electrode assembly, presses the curved portion of the electrode assembly. As described above, when both the flat portion and the curved portion of the electrode assembly are brought into a state of being pressed by the container, a space (surplus space) generated between a curved portion of an electrode assembly and an inner surface of a conventional prismatic container is eliminated, and it is possible to reduce or prevent a situation in which expansion of the curved portion of the electrode assembly relatively easily progresses with respect to expansion of the flat portion of the electrode assembly.

How the expansion of the electrode assembly generally progresses in a structure in which a wound electrode assembly is accommodated in the conventional prismatic container will be described below. At the initial stage of the life of an energy storage device, a plate defining a flat portion of the electrode assembly expands in a thickness direction of the plate and extends also in a longitudinal direction of the plate. However, at the end of the life of the energy storage device, the expansion of the electrode assembly in the thickness direction is restricted by being pressed against an inner surface of the container, and a frictional force between the inner surface of the container and the electrode assembly increases. This makes it difficult to extend the plate in the longitudinal direction. On the other hand, in a curved portion of the electrode assembly, a space (surplus space) between the electrode assembly and the inner surface of the container remains even at the end of the life of the energy storage device, and the extension of the plate in the longitudinal direction is continued. Thus, strong tensile stress is generated in the plate located at a boundary between the flat portion and the curved portion of the electrode assembly, and in the worst case, an electrode may be broken. Therefore, the inventors have conceived of and developed an energy storage apparatus according to an example embodiment of the present invention, and provided the energy storage apparatus in which the container of the energy storage device, configured using the wound electrode assembly, has a shape along the periphery (outer surface) of the electrode assembly to press the electrode assembly by the container, and the holding unit having a structure along the periphery (outer surface) of the container is used outside the container to press the outer surface of the container.

Specifically, an energy storage apparatus according to an example embodiment of the present invention is in a state where the flat portion of the electrode assembly is pressed by the flat wall of the container and the curved portion of the electrode assembly is pressed by the curved wall of the container and a state where the flat surface of the holding unit presses the outer surface of the flat wall of the container and the curved surface of the holding unit presses the outer surface of the curved wall of the container. That is, the holding unit can press the flat portion of the electrode assembly via the flat wall of the container and press the curved portion of the electrode assembly via the curved wall of the container. Accordingly, a combined pressing force of a pressing force from the flat wall of the container and a pressing force from the flat surface of the holding unit is applied to the flat portion of the electrode assembly. Similarly, a combined pressing force of a pressing force from the curved wall of the container and a pressing force from the curved wall of the holding unit is applied to the curved portion of the electrode assembly. Accordingly, a large pressing force exceeding strength of the container and sufficient for reducing or preventing expansion of the electrode assembly is applied to the electrode assembly, and deformation of the container due to the expansion of the electrode assembly can also be reduced or prevented. As a result, tension generated at a boundary between the flat portion and the curved portion of the electrode assembly can be reduced or prevented, and a defect of the electrode assembly can be reduced or prevented.

Examples of the defect of the electrode assembly include deformation of the electrode assembly which can cause lithium electrodeposition, a decrease in the capacity of the energy storage element, and damage to the electrode assembly caused by foil breakage. Note that stress applied to each of the container and the holding unit is designed to fall within an elastic range of each material.

(2) The energy storage apparatus described in (1) may further include an external structure or a case located outward of the holding unit, wherein the external structure or the case fixes or accommodates the holding unit, and an outer surface of the holding unit is pressed by the external structure or the case to make the curved surface of the holding unit press the outer surface of the curved wall of the container of the energy storage device and to make the flat surface of the holding unit press the outer surface of the flat wall of the container of the energy storage device.

According to the energy storage apparatus described in (2), a large pressing force is applied to the curved portion of the electrode assembly by three forces of a pressing force from the external structure or the case, the pressing force from the curved surface of the holding unit, and the pressing force from the curved wall of the container. At this time, the curved surface of the inner surface of the holding unit presses the curved wall of the container, and a large pressing force is also applied to the curved wall of the container by the pressing force from the external structure or the case and the pressing force from the holding unit. Further, the deformation of the container due to the expansion of the curved portion of each electrode assembly can be more reliably reduced or prevented. In addition, each curved portion of the electrode assembly is pressed from each curved wall of the container, and each flat portion of the electrode assembly is pressed from each flat wall of the container, and thus it is possible to reduce or prevent the expansion at both of each curved portion and each flat portion of the electrode assembly and to reduce or prevent an increase in tensile stress at a boundary portion between the curved portion and the flat portion. As described above, the expansion of the curved portion of the electrode assembly and the deformation of the container caused by the expansion can be further reduced or prevented, and as a result, the foil breakage of the electrode assembly can be further reduced or prevented. Examples of a method of applying pressure from the external structure or the case to the holding unit include a method of applying pressure to press and push an integral body (block), integrated by assembling the holding unit and the energy storage device, into the standard-size case, and a method of installing an integral body (block) in which the holding unit and the energy storage device are integrated in the standard-size case, inserting a member between the case and the block, and pressurizing the resultant. Note that the method of applying pressure from the external structure or the case to the holding unit in the present invention is not limited to the examples.

(3) In the energy storage apparatus described in (2), the holding unit may include a plurality of holding portions arranged in a direction in which the flat portion of the electrode assembly and the flat wall of the container face each other, and an inner surface of the holding portion may include the flat surface which presses the outer surface of the flat wall of the container and the curved surface which presses the outer surface of the curved wall of the container.

According to the energy storage apparatus described in (3), since each of the holding portions integrally includes the flat surface which presses the flat wall and the curved surface which presses the curved wall, both the expansion of the flat portion of the electrode assembly through the flat wall of the container and the expansion of the curved portion of the electrode assembly through the curved wall of the container can be reduced or prevented by the holding portion. That is, the entire electrode assembly can be pressed by the energy storage apparatus having a simple configuration, and as a result, the defect of the electrode assembly can be more reliably reduced or prevented.

(4) In the energy storage apparatus described in (2), the holding unit may include a pair of first holding portions sandwiching the energy storage device in a direction in which the curved portion of the electrode assembly and the curved wall of the container face each other, and a pair of second holding portions sandwiching the energy storage device in a direction in which the flat portion and the flat wall face each other, the pair of first holding portions may be members separate from the pair of second holding portions, an inner surface of the first holding portion may include the curved surface which presses the curved wall of the container, and an inner surface of the second holding portion may include the flat surface which presses the flat wall of the container.

According to the energy storage apparatus described in (4), since the first holding portion and the second holding portion are separate structures, it is not necessary to simultaneously install the first holding portion and the second holding portion, and the energy storage apparatus can be easily manufactured. Furthermore, a pressing force applied from the first holding portion to the curved wall of the container and a pressing force applied from the second holding portion to the flat wall of the container can be individually adjusted. Accordingly, even when a size of the energy storage device is changed due to a design change or a model change, if a shape of the container is partially the same, either one of the first holding portion and the second holding portion can be diverted to reduce a manufacturing cost.

(5) The energy storage apparatus described in (4) may include a plurality of the energy storage devices including a first energy storage device and a second energy storage device, the first energy storage device may include a first electrode assembly having a configuration identical to a configuration of the electrode assembly and a first container having a configuration identical to a configuration of the container, the first electrode assembly may have a flat shape including a first flat portion having a configuration identical to a configuration of the flat portion and a first curved portion having a configuration identical to a configuration of the curved portion, the first container may include a first flat wall having a configuration identical to a configuration of the flat wall and a first curved wall having a configuration identical to a configuration of the curved wall, the second energy storage device may include a second electrode assembly having a configuration identical to the configuration of the electrode assembly and a second container having a configuration identical to the configuration of the container, the second electrode assembly may have a flat shape including a second flat portion having a configuration identical to the configuration of the flat portion and a second curved portion having a configuration identical to the configuration of the curved portion, the second container may include a second flat wall having a configuration identical to the configuration of the flat wall and a second curved wall having a configuration identical to the configuration of the curved wall, a surface of the first flat wall included in the first container of the first energy storage device and a surface of the second flat wall included in the second container of the second energy storage device may face each other, an inner surface of the first holding portion may include a plurality of the curved surfaces integrated with each other, the plurality of curved surfaces may include a first curved surface facing the first curved wall and a second curved surface facing the second curved wall, an outer surface of the first curved wall in the first container may be pressed by the first curved surface of the first holding portion to cause a state in which the first curved portion of the first electrode assembly is pressed, and an outer surface of the second curved wall in the second container may be pressed by the second curved surface of the first holding portion to cause a state in which the second curved portion of the second electrode assembly is pressed.

According to the energy storage apparatus described in (5), since the plurality of curved surfaces (the first curved surface and the second curved surface) of the first holding portion face the curved walls of the plurality of energy storage devices (the first energy storage device and the second energy storage device), respectively, the plurality of curved surfaces (the first curved surface and the second curved surface) of the first holding portion can collectively press the plurality of curved walls (the first curved wall and the second curved wall). Furthermore, the number of the first holding portions may be smaller than that in a case where one first holding portion is disposed for one curved wall, and thus the assembly of the energy storage apparatus is facilitated. Although the first energy storage device and the second energy storage device have been described here, it is obvious that one first holding portion may include a plurality of curved surfaces respectively facing curved walls of two or more energy storage devices.

(6) In the energy storage apparatus according to any one of (1) to (5), the holding unit may include a foamed resin.

According to the energy storage apparatus described in (6), the holding unit is made of the foamed resin, and thus is easily formed along the shape of the curved wall of the container at the time of manufacturing. Furthermore, since the holding unit is formed using the foamed resin, weight reduction is possible, and manufacturing is easy. Various methods of forming the holding unit using the foamed resin are conceivable. The holding unit may be formed by disposing the energy storage device in the energy storage apparatus and then injecting and solidifying the foamed resin, or a structure of the holding unit molded in advance may be assembled together with the energy storage device and the like. The holding unit may include a combination of a portion filled with the foamed resin and then solidified inside the energy storage apparatus and a portion that is molded in advance before the assembly of the energy storage apparatus. For example, after the energy storage device and the second holding portion (a portion of the holding unit) which faces the flat wall of the energy storage device are positioned and disposed in the energy storage apparatus, the first holding portion (a portion of the holding unit) which faces the curved wall of the energy storage device may be formed by injecting the foamed resin. Note that, in this example, the second holding portion (a portion of the holding unit) molded in advance with a fixed shape is disposed in the energy storage apparatus together with the energy storage device. Furthermore, the second holding portion (a portion of the holding unit) may be formed using the foamed resin, or may be formed using a material different from the foamed resin. Alternatively, the holding unit may be formed by positioning and disposing the energy storage device and then injecting and solidifying the foamed resin once or a plurality of times. Portions of the holding unit, which are molded in advance with fixed shapes, may be assembled together with the energy storage device. The holding unit is formed using a material having sufficient strength even with the foamed resin and having an elastic region sufficient for reducing or preventing expansion of the electrode assembly. Note that the entire holding unit may be formed using the foamed resin, or only a portion of the holding unit may be formed using the foamed resin.

(7) In the energy storage apparatus according to any one of (1) to (6), the holding unit may include a refrigerant passage through which a refrigerant flows.

According to the energy storage apparatus described in (7), since the holding unit includes the refrigerant passage, the container can be efficiently cooled through the holding unit. Furthermore, a heating medium may be caused to flow through the refrigerant passage as a heating method.

Hereinafter, energy storage apparatuses and energy storage devices according to example embodiments (including modification examples thereof) of the present invention will be described with reference to the drawings. The example embodiments described below illustrates comprehensive or specific examples. Numerical values, shapes, materials, elements, disposed positions and connection modes of the elements, manufacturing processes, the order of the manufacturing processes, and the like illustrated in the following example embodiments are merely examples, and are not intended to limit the present invention. Dimensions and the like are not strictly illustrated in the drawings. In the drawings, the same or similar elements are denoted by the same reference signs. Names of members (elements) of the present example embodiment are used in the present example embodiment, and may be different from names of the members (elements) in the background art.

In the following description and drawings, a longitudinal direction of an energy storage device and a winding-axis direction of an electrode assembly provided in the energy storage device are defined as an X-axis direction. A direction in which a plurality of energy storage devices are arranged and a thickness direction of a container of the energy storage device are defined as a Y-axis direction. A direction in which a case lid and a case body of an energy storage apparatus are arranged or a vertical direction is defined as a Z-axis direction. The X-axis direction, the Y-axis direction, and the Z-axis direction are directions intersecting (in the present example embodiment, orthogonal to) each other. Although a case where the Z-axis direction is not the vertical direction depending on a usage mode is also conceivable, the following description will be given assuming the Z-axis direction as the vertical direction for convenience of description.

In the following description, an expression “insulation” means “electrical insulation”. It is preferable that an insulating material is formed of a material having a volume resistivity of 1×10¹⁰ Ωm or more.

In the following description, an X-axis plus direction indicates an X-axis arrow direction, and an X-axis minus direction indicates a direction opposite to the X-axis plus direction. The same applies to the Y-axis direction and the Z-axis direction. Further, strictly speaking, expressions indicating relative directions or postures, such as parallel and orthogonal, also include cases where the directions or postures are not exactly the same. Two directions being orthogonal to each other not only means that the two directions are completely orthogonal to each other, but also includes a state of being substantially orthogonal to each other, that is, a state of including a difference of about several percent.

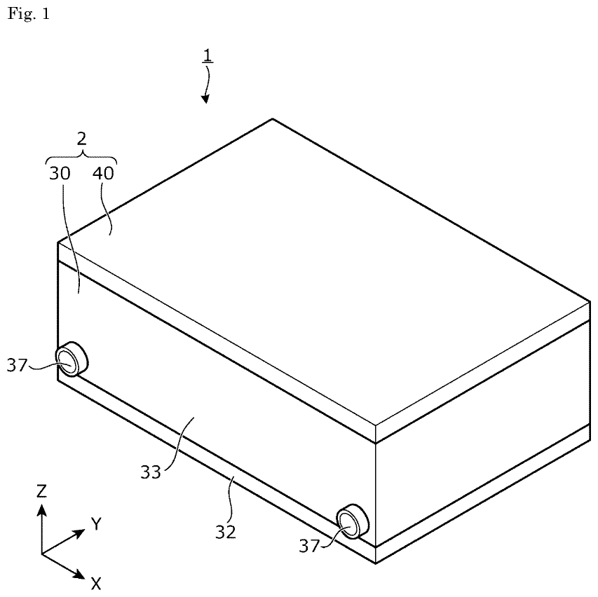

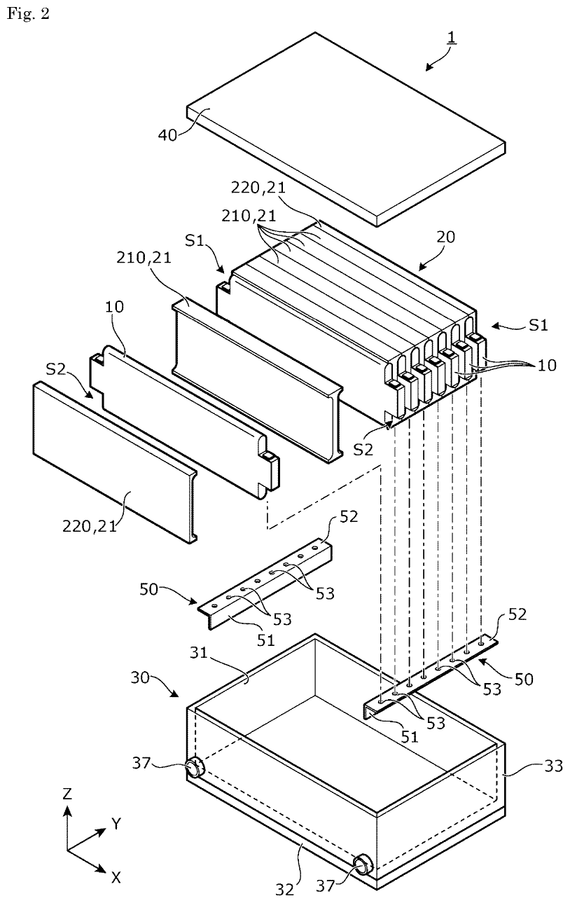

First, a schematic configuration of an energy storage apparatus 1 according to the present example embodiment will be described. FIG. 1 is a perspective view illustrating an appearance of the energy storage apparatus 1 according to the example embodiment. FIG. 2 is an exploded perspective view illustrating each element when the energy storage apparatus 1 according to the example embodiment is disassembled.

The energy storage apparatus 1 is an apparatus capable of charging electricity from the outside or discharging electricity to the outside, and has a substantially rectangular parallelepiped shape in the present example embodiment. The rectangular parallelepiped referred to herein is a hexahedron in which all faces are rectangular or square. The energy storage apparatus 1 is a battery module (assembled battery) used for power storage application, power supply application, or the like. Specifically, the energy storage apparatus 1 is used as a battery or the like for driving or starting an engine of a moving body such as an automobile, a motorcycle, a watercraft, a ship, a snowmobile, an agricultural machine, a construction machine, an automatic guided vehicle (AGV), or a railway vehicle for an electric railway. Examples of the automobile include an electric vehicle (EV), a hybrid electric vehicle (HEV), a plug-in hybrid electric vehicle (PHEV), and an automobile using a fossil fuel (gasoline, light oil, liquefied natural gas, or the like). Examples of the railway vehicle for an electric railway include a train, a monorail, a linear motor car, and a hybrid train including both a diesel engine and an electric motor. The energy storage apparatus 1 can also be used as a stationary battery or the like used for home use, business use, or the like.

As illustrated in FIG. 1 and FIG. 2, the energy storage apparatus 1 includes a case 2. In the case 2, a plurality of energy storage devices 10, a holding unit 20, a pair of exhaust members 50, a plurality of bus bars (not illustrated), and the like are accommodated. The energy storage apparatus 1 also includes external terminals (a positive electrode external terminal and a negative electrode external terminal) and the like for electrical connection with external devices, but the illustration and description thereof are omitted. In addition to the above-described elements, the energy storage apparatus 1 may include: binding members (an end plate, a side plate, and the like) which bind the plurality of energy storage devices 10; a bus bar holder which holds the bus bars; a bus bar cover; a circuit board which monitors or controls states of charge and states of discharge of the energy storage devices 10; and electric components such as a relay, a fuse, a shunt resistor, and a connector.

The case 2 is a container (case) having a substantially rectangular parallelepiped shape (box shape) which forms an outer case (casing or outer shell) of the energy storage apparatus 1. The case 2 is an example of an external structure. The case 2 is disposed outward of the plurality of energy storage devices 10, the holding unit 20, and the like, and presses the plurality of energy storage devices 10, the holding unit 20, and the like. The case 2 is a metal case formed using a metal member such as aluminum, an aluminum alloy, stainless steel, iron, or a plated steel plate. The case 2 may be formed using an insulating member such as a resin material. In a case where the case 2 is formed of a conductive material, an inner surface of the case 2 may be covered with an insulating material in order to ensure insulation with the energy storage devices 10.

As illustrated in FIG. 2, the case 2 includes a case body 30 forming a body of the case 2 and a case lid 40 forming a lid of the case 2. The case body 30 is a bottomed rectangular tubular housing (casing) in which an opening 31 is formed in the Z-axis plus direction, and accommodates the plurality of energy storage devices 10, the holding unit 20, and the like.

Specifically, the case body 30 includes a bottom wall 32 and a side wall 33. The bottom wall 32 is a flat plate-shaped rectangular portion disposed at an end of the case body 30 in the Z-axis minus direction.

The side wall 33 is a rectangular annular wall extending in the Z-axis plus direction from a peripheral edge of the bottom wall 32, and is provided continuously with respect to the entire circumference of the bottom wall 32. The opening 31 is formed inside the side wall 33. The side wall 33 is provided with a pair of exhaust ports 37, and is disposed in the Z-axis minus direction in the side wall 33 in the present example embodiment. Out of the pair of exhaust ports 37, one exhaust port 37 is disposed in the Z-axis minus direction and the X-axis minus direction, and the other exhaust port 37 is disposed at a corner in the Z-axis minus direction and the X-axis plus direction. That is, the pair of exhaust ports 37 is all disposed at the corners of the case body 30. Each of the exhaust ports 37 is a portion connecting the inside and the outside of the case 2, and releases gas discharged from each of the energy storage devices 10 to the outside of the case 2.

The case lid 40 is a flat rectangular member that closes the rectangular opening 31 of the case body 30. The case body 30 and the case lid 40 are joined by welding, fusion bonding, screwing, or the like, whereby the case 2 is sealed. The case body 30 and the case lid 40 may be formed using the same material or different materials.

The energy storage device 10 has a shape in which a length in the X-axis direction is longer than a length in the Y-axis direction, specifically, an elongated cylindrical shape which is flat in the Y-axis direction. In the present example embodiment, eight energy storage devices 10 are arranged in the Y-axis direction. The size of the energy storage device 10, the number of the energy storage devices 10 to be arranged, and the like are not particularly limited, and only one energy storage device 10 may be disposed. Each of the energy storage devices 10 may be covered with an insulating film. A configuration of the energy storage device 10 will be described in detail later.

The holding unit 20 holds each of the energy storage devices 10. In the present example embodiment, the holding unit 20 includes a plurality of holding portions 21 arranged in the Y-axis direction. One energy storage device 10 is disposed between two holding portions 21 adjacent to each other in the Y-axis direction. Details of the holding unit 20 will be described later.

The exhaust member 50 is a member constituting a flow passage through which gas discharged from at least one energy storage device 10 flows to the outside of the case 2. In the present example embodiment, the energy storage apparatus 1 includes the pair of exhaust members 50. Each of the exhaust members 50 is disposed at an end in the X-axis direction in the case body 30, and is a member having a surface that faces a gap between each of the energy storage devices 10 and each of the holding portions 21 and covers the gap.

The exhaust member 50 includes a first plate portion 51 and a second plate portion 52 bent with respect to the first plate portion 51. The first plate portion 51 is a rectangular plate-shaped portion which is parallel to a YZ plane and elongated in the Y-axis direction. The second plate portion 52 is a rectangular plate-shaped portion which is parallel to an XY plane and elongated in the Y-axis direction. The first plate portion 51 overlaps a portion of a second recess 102 of each of the energy storage devices 10 forming a space S2. The second plate portion 52 overlaps the other portion of the second recess 102 of each of the energy storage devices 10 forming the space S2. Accordingly, in the space S2, a gap between the adjacent energy storage devices 10 and a gap between the energy storage device 10 and the holding portion 21 adjacent to each other are covered with the first plate portion 51 and the second plate portion 52.

The second plate portion 52 is provided with a plurality of vent holes 53 at positions corresponding to gas release valves 800 of the respective energy storage devices 10. When the gas release valve 800 of a predetermined energy storage device 10 is opened so that gas is discharged, the gas enters the space S2 through the vent hole 53. Here, it is preferable that the vent hole 53 is larger than the gas release valve 800. An annular sealing member interposed between the second plate portion 52 and the energy storage device 10 may be disposed around the vent hole 53. The sealing member is formed using rubber or a porous resin. The sealing member prevents gas from leaking out of the space S2. The gas flows through the space S2 and is released from the exhaust port 37. At this time, since the exhaust member 50 covers the gap between the adjacent energy storage devices 10 and the gap between the energy storage device 10 and the holding portion 21 adjacent to each other, it is possible to reduce or prevent the gas from entering these gaps. Here, the exhaust member 50 having an L shape as viewed in the Y-axis direction is exemplified, but may have a U shape or a square tube shape. In any shape, the vent hole may be formed at a place corresponding to the gas release valve of each energy storage device.

The bus bars are connected (joined) to terminals 300 of the plurality of energy storage devices 10. Specifically, the plurality of bus bars connects the terminals 300 of two adjacent energy storage devices 10 among the plurality of energy storage devices 10, and electrically connects the terminals 300 of the energy storage device 10 arranged at an end to external terminals. A connection mode of the bus bars is not particularly limited, and the plurality of energy storage devices 10 may be connected in series or in parallel in any combination, or all the energy storage devices 10 may be connected in series or in parallel. The bus bar and the terminal 300 are connected (joined) by welding or the like, but a connection mode thereof is not particularly limited. The bus bar is formed using a conductive member made of metal such as aluminum, an aluminum alloy, copper, a copper alloy, or Ni, a combination thereof, a conductive member other than metal, or the like.

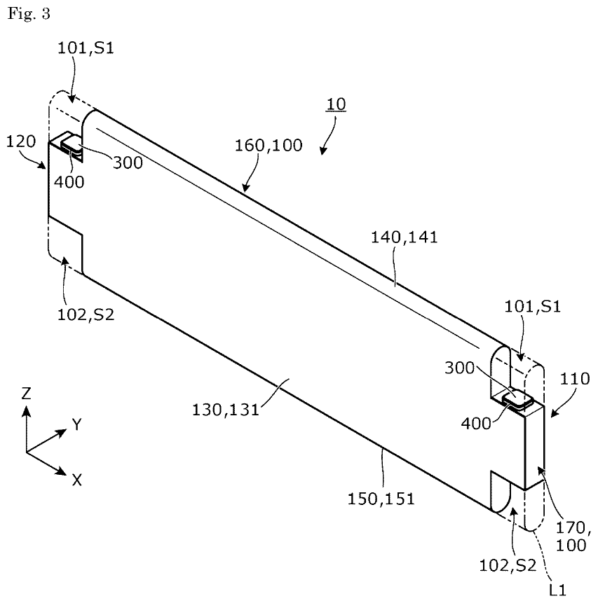

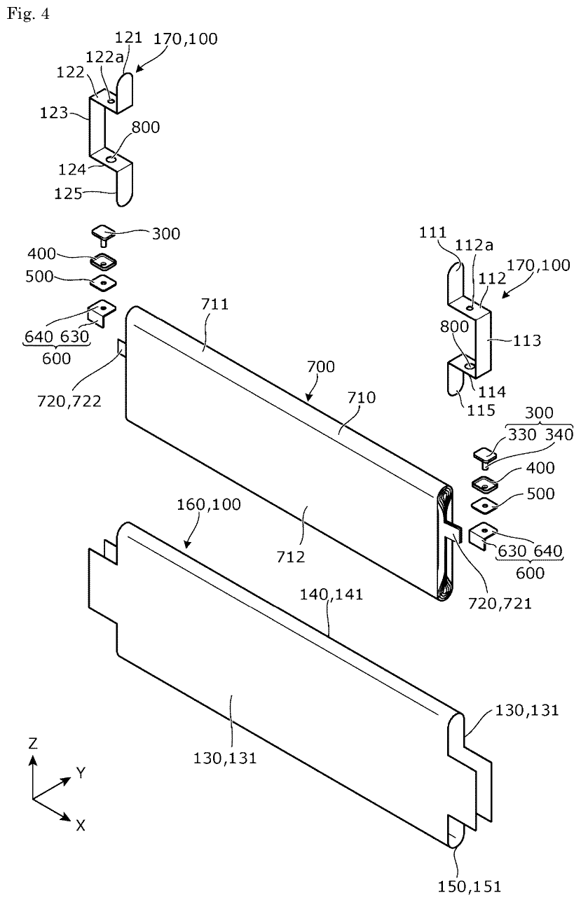

With reference to FIGS. 3 and 4, the energy storage device 10 according to the present example embodiment will be described in general. FIG. 3 is a perspective view illustrating an appearance of the energy storage device 10 according to the present example embodiment. FIG. 4 is an exploded perspective view illustrating each element of the energy storage device 10 according to the present example embodiment in an exploded manner.

The energy storage device 10 is an energy storage device capable of charging electricity from the outside or discharging electricity to the outside. The energy storage device 10 is not limited to a nonaqueous electrolyte secondary battery, and may be a secondary battery other than the nonaqueous electrolyte secondary battery. The energy storage device 10 may be an all-solid-state lithium battery using a solid electrolyte, or may be a polymer lithium battery. The energy storage device 10 may be a pouch-type energy storage device. In the present example embodiment, the energy storage device 10 having a flat elongated cylindrical shape as a reference is illustrated, but the shape of the energy storage device 10, that is, a shape of a container 100 is not limited to a shape based on the flat elongated cylindrical shape, and may be a shape based on a polygonal prism shape, an oval cylindrical shape, a cylindrical shape, or the like as long as the shape conforms to an outer surface of an electrode assembly 700 described later.

As illustrated in FIG. 3 and FIG. 4, in the present example embodiment, the energy storage device 10 includes the container 100, a pair of the terminals 300, and a pair of outer gaskets 400 outward of the container 100, and a pair of inner gaskets 500, a pair of current collectors 600, and the electrode assembly 700 are accommodated inside the container 100. Specifically, members of a positive electrode are disposed on a first side surface portion 110 which is an outer surface of the container 100 in the X-axis plus direction. Examples of the respective members of the positive electrode include the terminal 300, the outer gasket 400, the inner gasket 500, and the current collector 600. That is, the first side surface portion 110 is a portion forming an outer surface of the lid 170, which covers an end of the container 100 in the X-axis plus direction, and the respective members of the positive electrode are disposed on the first side surface portion 110. In the present example embodiment, the first side surface portion 110 is a portion within a range of 1% to 10% of a length of the container 100 in the X-axis direction from an end surface of the container 100 in the X-axis plus direction, but the first side surface portion 110 may be larger than 10% of the length of the container 100 in the X-axis direction when the length of the container 100 in the X-axis direction is less than three times a length of the container 100 in the Z-axis direction.

Members of a negative electrode are disposed on a second side surface portion 120 which is an outer surface of the container 100 in the X-axis minus direction. Examples of the respective members of the negative electrode include the terminal 300, the outer gasket 400, the inner gasket 500, and the current collector 600. That is, the second side surface portion 120 is a surface forming an outer surface of the lid 170 which covers an end of the container 100 in the X-axis minus direction, and the respective members of the negative electrode are disposed on the second side surface portion 120. The second side surface portion 120 is a portion within a range of 1% to 10% of a length of the container 100 in the X-axis direction from an end surface of the container 100 in the X-axis minus direction, but the second side surface portion 120 may be larger than 10% of the length of the container 100 in the X-axis direction when the length of the container 100 in the X-axis direction is less than three times a length of the container 100 in the Z-axis direction.

Although an electrolyte solution (nonaqueous electrolyte) is sealed in the container 100, the illustration thereof is omitted. The kind of the electrolyte solution is not particularly limited as long as performance of the energy storage device 10 is not impaired. In addition to the above elements, a spacer may be disposed on the side of, above, or below the electrode assembly 700, or an insulating film or the like enclosing the electrode assembly 700 and the like may be disposed.

The container 100 is a case having an outer shape having, as a reference, an elongated cylindrical shape elongated in the X-axis direction and flat in the Y-axis direction. In the present example embodiment, the length of the container 100 in the X-axis direction is equal to or more than three times the length of the container 100 in the Z-axis direction, and the length of the container 100 in the X-axis direction is equal to or more than five times the length of the container 100 in the Y-axis direction. In FIG. 3, a region having the elongated cylindrical region as the reference of the outer shape of the container 100 is indicated by a two-dot chain line L1. In the present example embodiment, the container 100 includes notches at an end in the Z-axis plus direction and an end in the Z-axis minus direction at each end in the winding-axis direction (X-axis direction) of the electrode assembly 700. It can also be said that the container 100 has a total of four notches (two pairs of notches) with two notches (a pair of notches) disposed at the end of the container 100 in the X-axis plus direction and two notches (a pair of notches) disposed at the end of the container 100 in the X-axis minus direction. Each of the notches is a portion where the corner of the container 100 is cut out, and is cut out in a rectangular shape as viewed in the Y-axis direction. In other words, the outer shape of the container 100 has a shape in which rectangular notches as viewed in the Y-axis direction are formed at upper and lower portions of both the ends in the X-axis direction with respect to the elongated cylindrical shape elongated in the X-axis direction and flat in the Y-axis direction. It can also be said that each of the notches forms a recess in which a portion of the elongated cylindrical shape as the reference is recessed. Among the plurality of notches, each of the pair of notches located at the upper portion of the container 100 is a first recess 101, and each of the pair of notches located at the lower portion of the container 100 is a second recess 102. The terminal 300 is disposed in the first recess 101, and the gas release valve 800 (see FIGS. 3 and 4) is disposed in the second recess 102. Specifically, the gas release valves 800 are disposed on surfaces (a first lower surface 114 and a second lower surface 124: described later) of the second recess 102 facing the Z-axis minus direction. The gas release valve 800 is a safety valve that releases the pressure when the pressure inside the container 100 excessively increases.

The container 100 includes a container body 160 and a pair of the lids 170, and has a cylindrical shape elongated in the X-axis direction by assembling the container body 160 and the respective lids 170. The container body 160 includes a pair of flat walls 131 and a pair of curved walls 141 and 151, and the pair of flat walls 131 and the pair of curved walls 141 and 151 form a cylindrical shape penetrated in the X-axis direction and is elongated in the X-axis direction. Each of the lids 170 of the pair of lids 170 is a plate-shaped member that closes each end in the X-axis direction of the container body 160, and is included in a wall included in the container 100. The lid 170 located in the X-axis minus direction closes the end of the container body 160 in the X-axis minus direction, and the lid 170 located in the X-axis plus direction closes the end of the container body 160 in the X-axis plus direction. Each of the lids 170 is formed by bending metal punched into a flat shape by pressing so as to match a shape of the opposed end in the X-axis direction of the container body 160.

With such a configuration, the container 100 has a structure in which the inside is sealed by accommodating the electrode assembly 700 and the like in the container body 160 and then joining the container body 160 and the lid 170 by welding or the like. A material of the container 100 (the container body 160 and the lid 170) is not particularly limited, but weldable metal such as stainless steel, aluminum, an aluminum alloy, iron, or a plated steel plate is preferable.

Although not illustrated, an electrolyte solution filling portion is formed in the container body 160 or the lid 170. The electrolyte solution filling portion is a portion for electrolyte solution filling of an electrolyte solution into the inside of the container 100 at the time of manufacturing the energy storage device 10.

The container body 160 includes the pair of flat walls 131 and the pair of curved walls 141 and 151. Each of the curved walls 141 of the pair of curved walls 141 is a wall that is elongated in the X-axis direction and faces a curved portion 711 of the electrode assembly 700. An inner surface of each of the curved walls 141 has a curved shape along the curved portion 711 of the electrode assembly 700. Specifically, the inner surface of the curved wall 141 in the Z-axis plus direction is curved so as to be recessed in the Z-axis plus direction, and an inner surface of the curved wall 151 in the Z-axis minus direction is curved so as to be recessed in the Z-axis minus direction. In the present example embodiment, outer surfaces of the curved walls 141 and 151 are also curved, the curved wall 141 is formed in a curved plate shape protruding in the Z-axis plus direction, and the curved wall 151 is formed in a curved plate shape protruding in the Z-axis minus direction. Each of the flat walls 131 of the pair of flat walls 131 is a wall that is elongated in the X-axis direction and faces a flat portion 712 of the electrode assembly in the Y-axis direction. Each of the flat walls 131 is formed in a flat plate shape parallel to an XZ plane, and an inner surface of the flat wall 131 is disposed along the flat portion 712 of the electrode assembly 700. In the present example embodiment, an end of each of the flat walls 131 includes a portion protruding in the X-axis direction more than the other portion such that the end of each of the flat walls 131 and the end of the lid 170 having a bent shape are joined without a gap. Specifically, since a center portion of the lid 170 in the Z-axis direction has a shape bent so as to protrude in the X-axis direction, a center portion in the Z-axis direction of the end of the flat wall 131 in the X-axis direction protrudes in the X-axis direction more than the other portion of the end of the flat wall 131.

In the container body 160, an outer surface of each of the flat walls 131 includes a long side surface 130, the outer surface of the curved wall 141 includes a top surface 140, and the outer surface of the curved wall 151 includes a bottom surface 150. The long side surface 130 is a surface elongated in the X-axis direction and parallel to the XZ plane, and a pair of the long side surfaces 130 are disposed back to back in the Y-axis direction. The top surface 140 is a surface elongated in the X-axis direction and curved so as to protrude in the Z-axis plus direction along the curved portion 711 of the electrode assembly 700, and is located in the Z-axis plus direction with respect to the long side surface 130. The bottom surface 150 is a surface elongated in the X-axis direction and curved so as to protrude in the Z-axis minus direction along the curved portion 711 of the electrode assembly 700, and is located in the Z-axis minus direction with respect to the long side surface 130.

The outer surface of the lid 170 in the X-axis plus direction out of the pair of lids 170 includes the first side surface portion 110. The first side surface portion 110 includes a first upper side surface 111, a first upper surface 112, a first middle side surface 113, a first lower surface 114, and a first lower side surface 115. The first upper side surface 111 and the first lower side surface 115 are surfaces parallel to the YZ plane. The first upper side surface 111, the first middle side surface 113, and the first lower side surface 115 are surfaces parallel to the YZ plane. The first upper side surface 111 is a surface that is continuous with the first upper surface 112 and is located at the outermost position in the Z-axis plus direction out of the outer surface of the lid 170 in the X-axis plus direction. The first lower side surface 115 is continuous with the first lower surface 114, and is a surface located at the outermost position in the Z-axis minus direction out of the outer surface of the lid 170 in the X-axis plus direction. The first middle side surface 113 is a surface continuous with the first upper surface 112 and the first lower surface 114, and is disposed at a position sandwiched between the first upper side surface 111 and the first lower side surface 115 in the Z-axis direction as viewed in the X-axis direction. Out of the pair of lids 170, the outer surface of the lid 170 in the X-axis minus direction includes the second side surface portion 120. The second side surface portion 120 includes a second upper side surface 121, a second upper surface 122, a second middle side surface 123, a second lower surface 124, and a second lower side surface 125. Since a configuration of the outer surface of the lid 170 in the X-axis minus direction is the same as a configuration of the outer surface of the lid 170 in the X-axis plus direction, the description thereof is omitted.

The terminals 300 are terminals (a positive electrode terminal and a negative electrode terminal) electrically connected to the electrode assembly 700 through the current collectors 600. That is, the terminal 300 is a metal member for leading out electricity stored in the electrode assembly 700 to a space outside the energy storage device 10 or for introducing electricity into a space inside the energy storage device 10 to store the electricity in the electrode assembly 700. A material of the terminal 300 is not particularly limited, but the terminal 300 is formed using a conductive member such as aluminum, an aluminum alloy, copper, or a copper alloy. The terminal 300 is connected (joined) to the current collector 600 by caulking, welding, or the like, and is attached to the lid 170.

In the present example embodiment, the terminal 300 includes a terminal body 330 and a shaft 340 protruding from the terminal body 330. The terminal body 330 is a portion protruding outward from a terminal installation surface of the container 100. Here, the terminal installation surface is a surface facing the Z-axis plus direction in each of the first recesses 101, the terminal installation surface located in the X-axis plus direction is the first upper surface 112, and the terminal installation surface located in the X-axis minus direction is the second upper surface 122. In the present example embodiment, the terminal body 330 protrudes from the terminal installation surface outward of the container 100 in the Z-axis plus direction. In the lids 170, through holes 112a and 122a through which the shafts 340 pass are formed in walls (in the present example embodiment, the first upper surface 112 and the second upper surface 122) including the terminal installation surfaces, respectively. The shaft 340 is crimped in a state of passing through the wall (in the present example embodiment, each of the first upper surface 112 and the second upper surface 122) including the terminal installation surface, the outer gasket 400, the inner gasket 500, and the current collector 600, whereby the terminal 300 and the current collector 600 are connected (joined) to each other. During or after the connection, each of the lids 170 may be bent so as to match the shape of the end in the X-axis direction of the container body 160.

The current collectors 600 are disposed one by one at the respective ends of the electrode assembly 700 in the X-axis direction. The current collectors 600 are conductive members (a positive electrode current collector and a negative electrode current collector) that are connected (joined) to the electrode assembly 700 and the terminals 300 to electrically connect the electrode assembly 700 and the terminals 300. The current collector 600 integrally includes a first joint portion 630 and a second joint portion 640. Specifically, the first joint portion 630 of the current collector 600 and a tab portion 720 of the electrode assembly 700, which will be described later, are connected (joined) to each other by welding, caulking, or the like, and the second joint portion 640 of the current collector 600 and the terminal 300 are connected (joined) to each other by caulking, welding, or the like. Each of the first joint portion 630 and the second joint portion 640 is a portion having a flat plate shape, and is formed by bending one metal plate. Although a material of the current collector 600 is not particularly limited, the positive electrode current collector is formed using a conductive member such as aluminum or an aluminum alloy, and the negative electrode current collector is formed using a conductive member such as copper or a copper alloy.

The outer gasket 400 is a member that is disposed between the lid 170 of the container 100 and the terminal 300, provides insulation between the lid 170 and the terminal 300, and seals the inside of the container 100. In the present example embodiment, the outer gasket 400 is a plate-shaped rectangular insulating member. The inner gasket 500 is a member that is disposed between the lid 170 and the current collector 600, provides insulation between the lid 170 and the current collector 600, and seals the inside of the container 100. In the present example embodiment, both the outer gasket 400 and the inner gasket 500 are plate-shaped and rectangular insulating members. A material of each of the outer gasket 400 and the inner gasket 500 may be a resin having electrical insulation properties such as polypropylene (PP), polyethylene (PE), polystyrene (PS), an ABS resin, or a composite material thereof.

The electrode assembly 700 is an energy storage element (power generating element) formed by winding a plate. The electrode assembly 700 has an elongated cylindrical shape that is elongated and extends in the X-axis direction. Since a length in the Y-axis direction of the electrode assembly 700 is shorter than a length in the X-axis direction and a length in the Z-axis direction of the electrode assembly 700, it can be said that the electrode assembly 700 has a flat shape. The length of the electrode assembly 700 in the X-axis direction is 300 mm or more, specifically, about 500 mm to 1500 mm. The length of the electrode assembly 700 in the X-axis direction is longer than the length of the electrode assembly 700 in the Z-axis direction, and the length of the electrode assembly 700 in the X-axis direction is equal to or more than three times the length of the electrode assembly 700 in the Z-axis direction. The electrode assembly 700 includes a main body 710 and a plurality of the tab portions 720 protruding from the main body 710, and the tab portion 720 and the current collector 600 are connected (joined) to each other as described above.

In the present example embodiment, each one of the plurality of tab portions 720 protrudes from one of both end surfaces of the main body 710 in the X-axis direction. A positive electrode tab portion 721 is provided on the end surface (one end surface) of the main body 710 in the X-axis plus direction, and a negative electrode tab portion 722 is provided on the end surface (the other end surface) of the main body 710 in the X-axis minus direction.

The energy storage device 10 is manufactured by the following manufacturing method. First, the container body 160 is formed by extrusion or by rounding a metal sheet and welding ends in the Z-axis direction to each other. The container body 160 may be formed by welding a plurality of divided bodies divided on the XY plane. Then, the electrode assembly 700 is inserted into the container body 160. After the insertion, the current collector 600 is connected to each of the tab portions 720 of the positive and negative electrodes. Then, after the outer gasket 400, the inner gasket 500, the lid 170, and the terminal 300 are assembled to each of the current collectors 600, the respective lids 170 are welded to both the ends of the container body 160. Thereafter, the electrolyte solution is injected into the container 100 from the electrolyte solution filling portion, and the electrolyte solution filling portion is sealed.

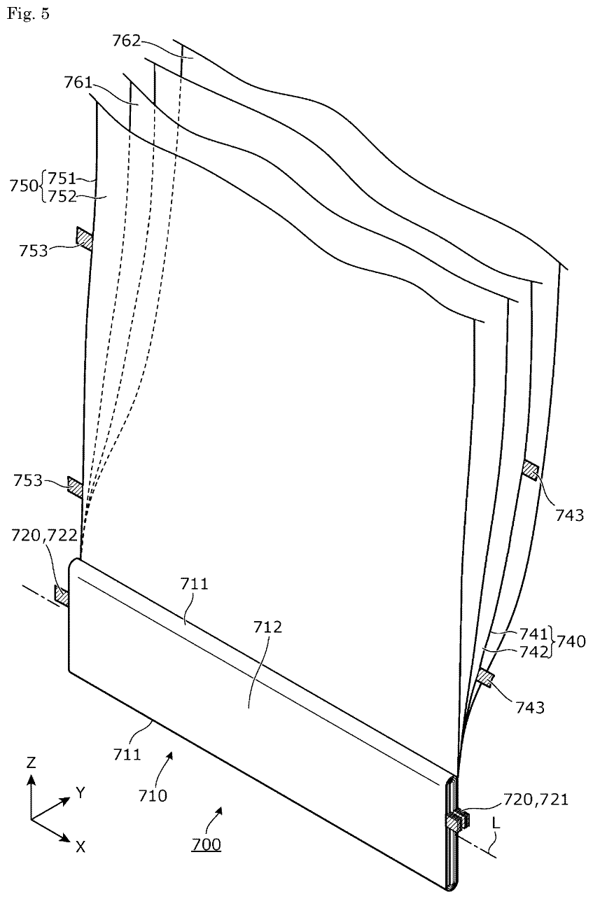

FIG. 5 is a perspective view illustrating a configuration of the electrode assembly 700 according to the present example embodiment. Specifically, FIG. 5 illustrates a state in which winding of plates in the electrode assembly 700 is partially developed. As illustrated in FIG. 5, the electrode assembly 700 includes a positive electrode plate 740, a negative electrode plate 750, and separators 761 and 762.

The positive electrode plate 740 is a plate (electrode plate) in which a positive active material layer 742 is disposed on both surfaces of a positive electrode current collector foil 741 which is an elongated strip-shaped metal foil. The positive electrode current collector foil 741 is made of aluminum, an aluminum alloy, or the like. The negative electrode plate 750 is a plate (electrode plate) in which a negative active material layer 752 is disposed on both surfaces of a negative electrode current collector foil 751 which is an elongated strip-shaped metal foil. The negative electrode current collector foil 751 is made of copper, a copper alloy, or the like. As a positive active material used for the positive active material layer 742 and a negative active material used for the negative active material layer 752, a known material can be appropriately used as long as the material is capable of occluding and releasing a lithium ion.

As the positive active material, a polyanion compound such as LiMPO₄, LiMSiO₄, or LiMBO₃ (M represents one or more transition metal elements selected from Fe, Ni, Mn, Co, and the like), lithium titanate, a spinel-type lithium manganese oxide such as LiMn₂O₄ or LiMn_{1.5}Ni_{0.5}O₄, a lithium transition metal oxide such as LiMO₂ (M represents one or more transition metal elements selected from Fe, Ni, Mn, Co, and the like) having an α-NaFeO₂-type crystal structure, or the like can be used. Examples of the negative active material include lithium metal, an alloy capable of occluding and releasing lithium, a carbon material (graphite, non-graphitizable carbon, graphitizable carbon, low-temperature calcined carbon, amorphous carbon, or the like), and a silicon oxide.

Here, in a case where the positive active material is an active material having an α-NaFeO₂-type crystal structure and contains Ni, it is preferable to set the ratio of the mass of Ni to the mass of the transition metal contained in the positive active material to 50% or more in order to increase the energy density of the electrode assembly 700. The positive active material layer contains optional components such as a positive active material other than the lithium transition metal composite oxide, a conductive agent, a binder, a thickener, and a filler as necessary.

The separators 761 and 762 are microporous sheets made of a resin. As a material of the separators 761 and 762, a known material can be appropriately used as long as the performance of the energy storage device 10 is not impaired. As the separators 761 and 762, a woven fabric, a nonwoven fabric, a synthetic resin microporous membrane made of a polyolefin resin such as polyethylene, or the like insoluble in an organic solvent may be used.

The electrode assembly 700 is formed by winding the positive electrode plate 740, the negative electrode plate 750, and the separators 761 and 762. The electrode assembly 700 is formed by layering and winding the negative electrode plate 750, the separator 761, the positive electrode plate 740, and the separator 762 in this order. In the present example embodiment, the positive electrode plate 740, the negative electrode plate 750, and the separators 761 and 762 are wound about an winding axis L extending in the X-axis direction to form the wound electrode assembly 700. The winding axis L is a virtual axis which is a central axis when the positive electrode plate 740, the negative electrode plate 750, and the separators 761 and 762 are wound. The winding axis of the present example embodiment is a straight line which passes through the center of the electrode assembly 700 and is parallel to the X-axis direction.

A plurality of protruding pieces 743 protruding outward is disposed at an interval on an end edge of the positive electrode plate 740 in the X-axis plus direction. Similarly, a plurality of protruding pieces 753 protruding outward is disposed at an interval on an end edge of the negative electrode plate 750 in the X-axis minus direction. Each protruding piece 743 of the plurality of protruding pieces 743 is a portion (positive active material layer non-forming portion) where the positive active material layer is not disposed and the positive electrode current collector foil 741 is exposed. Each protruding piece 753 of the plurality of protruding pieces 753 is a portion (negative active material layer non-forming portion) where the negative active material layer is not disposed and the negative electrode current collector foil 751 is exposed. In FIG. 5, the active material layer non-forming portions (the positive active material layer non-forming portion and the negative active material layer non-forming portion) are indicated by hatching.

When the positive electrode plate 740, the negative electrode plate 750, and the separators 761 and 762 are wound, the plurality of protruding pieces 743 of the positive electrode plate 740 substantially overlaps on the end surface (one end surface) of the main body 710 in the X-axis plus direction, and the plurality of protruding pieces 753 of the negative electrode plate 750 substantially overlaps on the end surface (the other end surface) in the X-axis minus direction. In the positive electrode plate 740, a portion where the plurality of protruding pieces 743 overlaps is the positive electrode tab portion 721. That is, the positive electrode tab portion 721 is a portion where a plurality of pieces (the protruding pieces 743) included in a plate (the positive electrode plate 740) having the same polarity among a plurality of plates (the positive electrode plate 740 and the negative electrode plate 750) is layered. Hereinafter, the expression of superposing or overlapping is not limited to integral stacking in a strict sense. “Superposing” and “overlapping” include a superposition state with variation (deviation) in a direction perpendicular to a superposing direction.

Similarly, a portion of the negative electrode plate 750 where the plurality of protruding pieces 753 overlaps is the negative electrode tab portion 722. That is, the negative electrode tab portion 722 is a portion where a plurality of pieces (the protruding pieces 753) included in a plate (the negative electrode plate 750) having the same polarity among a plurality of plates (the positive electrode plate 740 and the negative electrode plate 750) is layered.

As described above, the electrode assembly 700 includes the main body 710 which forms a body of the electrode assembly 700, and the tab portions 720 (the positive electrode tab portion 721 and the negative electrode tab portion 722) protruding from the respective end surfaces of the main body 710 in the X-axis direction. In other words, the electrode assembly 700 includes a pair of tab portions including the positive electrode tab portion 721 and the negative electrode tab portion 722.

The main body 710 is an elongated cylindrical portion formed by winding a portion of the positive electrode plate 740 where the positive active material layer 742 is disposed (by formation or coating), a portion of the negative electrode plate 750 where the negative active material layer 752 is disposed (by formation or coating), and the separators 761 and 762. In the main body 710, a region where at least one of the positive active material layer 742 and the negative active material layer 752 is layered is referred to as the active material layer forming portion. An outer surface of the main body 710 includes the curved portions 711 at both ends in the Z-axis direction and the flat portions 712 at both ends in the Y-axis direction. In other words, the outer surface of the main body 710 includes the pair of curved portions 711 and the pair of flat portions 712. Each of the flat portions 712 of the pair of flat portions 712 is located between the pair of curved portions 711 in the Z-axis direction and is flat as a whole. It can also be said that the pair of curved portions 711 is disposed at positions sandwiching each of the flat portions 712 in the Z-axis direction.

The curved portion 711 is a portion that extends in the X-axis direction and protrudes in a curved shape in the Z-axis direction. As viewed in the X-axis direction, the curved portion 711 is curved in a semicircular arc shape. The curved portion 711 located in the Z-axis plus direction and the curved wall 141 of the container body 160 face each other in the Z-axis direction, and the curved portion 711 located in the Z-axis minus direction and the curved wall 151 of the container body 160 face each other in the Z-axis direction. That is, the curved portion 711 faces the curved walls 141 and 151 in the Z-axis direction.

The flat portion 712 is a flat portion that extends in the X-axis direction, connects ends of the pair of curved portions 711, and is parallel to the XZ plane. The flat portion 712 is a surface perpendicular to the Y-axis direction. The flat portions 712 are disposed to face the flat walls 131 of the container body 160, respectively. In a portion of the electrode assembly 700 sandwiched between the flat portions 712, a plurality of wound plates and separators (the positive electrode plate 740, the negative electrode plate 750, and the separators 761 and 762) are layered in the Y-axis direction. Here, the main layering direction of the plurality of plates is defined as the Y-axis direction.

The curved shape of the curved portion 711 as viewed in the X-axis direction is not limited to the semicircular arc shape, and may be a shape such as a portion of an elliptic shape, a polygonal shape, or the like. The flat portion 712 is not limited to a case where an outer surface of the electrode assembly 700 perpendicular to the Y-axis direction is completely flat, and the outer surface may be slightly recessed or may slightly bulge.

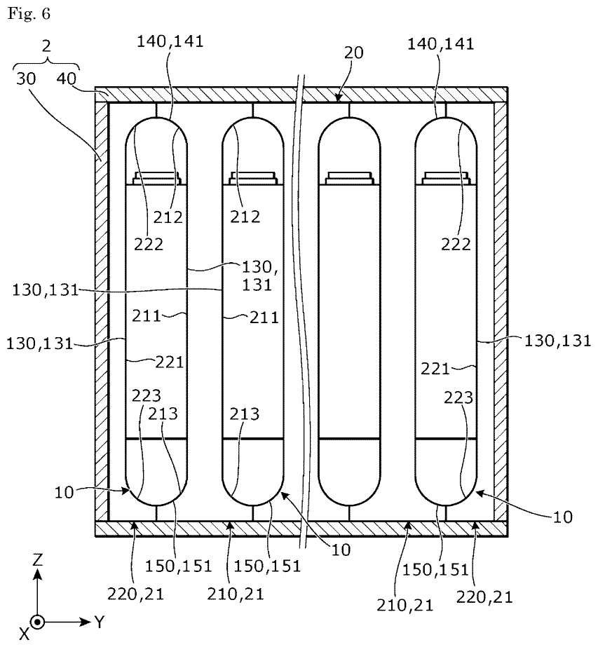

FIG. 6 is an explanatory view illustrating the holding unit 20, the case 2, and the energy storage device 10 according to the example embodiment. In FIG. 6, only the case 2 is illustrated in a cross-sectional view. As illustrated in FIG. 6, the holding unit 20 here includes the plurality of holding portions 21 arranged in the Y-axis direction.

The holding portions 21 are members which are disposed alternately with the energy storage devices 10 in the Y-axis direction and hold the energy storage devices 10, and perform insulation and/or heat insulation between the energy storage devices 10 and between the energy storage devices 10 and other members. In the present example embodiment, the holding portion 21 is disposed so as to directly face the flat wall 131 of the container 100 and at least a portion of the curved wall 141 of the container 100 and to be superposed on a region of the active material layer forming portion in the electrode assembly 700 (See FIGS. 2 and 4). The holding portion 21 is an insulating plate-shaped member which is disposed adjacent to the energy storage device 10 in the Y-axis plus direction or the Y-axis minus direction of the energy storage device 10 and insulates the energy storage devices 10 from each other or insulates the energy storage device 10 from the case 2. The holding portion 21 may be formed using an insulating member such as PC, PP, PE, PS, an ABS resin, or a composite material thereof, or may be formed using a metal member whose surface is subjected to insulation processing.

Each of the holding portions 21 may be made of a material having high thermal conductivity from the viewpoint of cooling properties. Each of the holding portions 21 may be made of an insulating material having higher thermal conductivity than polypropylene. Alternatively, each of the holding portions 21 may be mainly formed using metal, and the surface thereof may be covered with an insulating material. Each of the holding portions 21 may be formed using a heat insulating material in order to avoid thermal influence from an adjacent energy storage device. Examples of the heat insulating material include a member having heat insulating properties such as mica.

In an intermediate spacer 210, a flat surface 211 and curved surfaces 212 and 213 which face the Y-axis minus direction overlap and come into contact with surfaces facing the Y-axis plus direction of the energy storage device 10 adjacent to the intermediate spacer 210 at a position in the Y-axis minus direction. Specifically, in the container 100 of the energy storage device 10 which is adjacent to the intermediate spacer 210 at the position in the Y-axis minus direction, the outer surface of the flat wall 131, the outer surface of the curved wall 141 and the outer surface of the curved wall 151, which face the Y-axis plus direction, come into surface contact with the flat surface 211 and the curved surfaces 212 and 213, which face the Y-axis minus direction, of the intermediate spacer 210. In the present example embodiment, the curved surface 212 is in contact with the outer surface of the curved wall 141 up to the outermost position in the Z-axis plus direction (a vertex of the outer surface of the curved wall 141), but a portion of the outer surface of the curved wall 141 may not face and be in contact with the curved surface 212. Similarly, the curved surface 213 is in contact with the outer surface of the curved wall 151 up to the outermost position (a vertex of the outer surface of the curved wall 151) in the Z-axis minus direction, but a portion of the outer surface of the curved wall 151 may not face and be in contact with the curved surface 212.

Similarly, the flat surface 211 and the curved surfaces 212 and 213, which face the Y-axis plus direction, of the intermediate spacer 210 overlap surfaces facing the Y-axis minus direction of the energy storage device 10, adjacent to the intermediate spacer 210 in the Y-axis plus direction. Specifically, the outer surface of the flat wall 131, the outer surface of the curved wall 141, and the outer surface of the curved wall 151, which face the Y-axis minus direction, in the container 100 of the energy storage device 10, adjacent to the intermediate spacer 210 at a position in the Y-axis plus direction, come into surface contact with the flat surface 211 and the curved surfaces 212 and 213, which face the Y-axis plus direction, of the intermediate spacer 210. In the present example embodiment, the curved surface 212 is in contact with the outer surface of the curved wall 141 up to the outermost position in the Z-axis plus direction (a vertex of the outer surface of the curved wall 141), but a portion of the outer surface of the curved wall 141 may not face and be in contact with the curved surface 212. Similarly, the curved surface 213 is in contact with the outer surface of the curved wall 151 up to the outermost position (a vertex of the outer surface of the curved wall 151) in the Z-axis minus direction, but a portion of the outer surface of the curved wall 151 may not face and be in contact with the curved surface 212.

In an end spacer 220 disposed in the Y-axis minus direction, an end surface in the Y-axis minus direction is formed in a flat shape along an inner surface of the case body 30, and an end surface in the Y-axis plus direction is formed in a shape recessed in the Y-axis minus direction along the outer shape of the adjacent energy storage device 10. A flat surface 221 and curved surfaces 222 and 223 of the end spacer 220 overlap and come into contact with surfaces facing the Y-axis minus direction of the energy storage device 10 adjacent in the Y-axis plus direction.

Similarly, in the end spacer 220 disposed in the Y-axis plus direction, an end surface in the Y-axis plus direction is formed in a flat shape along the inner surface of the case body 30, and an end surface in the Y-axis minus direction is formed in a shape recessed in the Y-axis plus direction along the outer shape of the adjacent energy storage device 10. A flat surface 221 and curved surfaces 222 and 223 of the end spacer 220 overlap and come into contact with surfaces facing the Y-axis plus direction of the energy storage device 10 adjacent in the Y-axis minus direction.

In the present example embodiment, since the inner surface of the flat wall 131 of the container 100 is in contact with the flat portion 712 of the electrode assembly 700 and the inner surface of the curved wall 141 is in contact with the curved portion 711 of the electrode assembly 700, expansion of the curved portion 711 can be reduced or prevented and restricted. Accordingly, damage to the curved portion 711 and a boundary between the curved portion 711 and the flat portion 712 can be reduced or prevented.

In particular, in FIG. 6, the holding unit 20 holding the energy storage devices 10 presses the energy storage devices 10 in the Y-axis direction and the Z-axis direction. Here, at the time of BOL (Beginning of Life) of the energy storage device 10, a reaction force in the Y-axis direction and a reaction force in the Z-axis direction, which are applied to the energy storage device 10 by the holding unit 20, are 1 kN or more and 5 kN or less.

A wall thickness of the end spacer 220 and a wall thickness of the intermediate spacer 210 are larger than a wall thickness of the container 100 in each of the Y-axis direction and the Z-axis direction which are pressing directions. Furthermore, strength of the holding unit 20 is larger than strength of the container 100. The holding unit 20 has sufficient strength to press the electrode assembly 700, and an inner surface of the holding unit 20 includes the curved surfaces 212 and 222, which face most of the curved wall 141 of the container 100, and the flat surface 221 which faces most of the flat wall 131 of the container 100. Since the container 100 is directly interposed between both the holding unit 20 and the electrode assembly 700, when the holding unit 20 presses the outer surface of the container 100, the pressing from the holding unit 20 is transmitted to the electrode assembly 700 through the container 100. Accordingly, it is possible to apply a pressing force exceeding the strength of the container 100 to the electrode assembly 700, and it is possible to reduce or prevent deformation of the container 100 due to the expansion of the electrode assembly 700. That is, it is possible to reduce or prevent the expansion of the electrode assembly 700 from progressing beyond a dimension of the container 100. As a result, tension generated at the boundary between the flat portion 712 and the curved portion 711 can be reduced or prevented.

In particular, since the curved portion 711 of the electrode assembly 700 is in contact with the inner surface of the curved wall 141, stress is applied from the curved wall 141 to the curved portion 711, and expansion of the curved portion 711 can be more reliably reduced or prevented by the curved wall 141. Since there is no room for the expansion of the curved portion 711 in the container 100, a dimensional change of the electrode assembly 700 can be restricted.

Further, since the outer surface of the curved wall 141 is in surface contact with the curved surfaces 212 and 222 of the holding unit 20, stress is applied from the curved surfaces 212 and 222 to the curved wall 141. Thus, even if the curved wall 141 is to expand due to the electrode assembly 700, the expansion can be more reliably reduced or prevented by the curved surfaces 212 and 222. The curved surfaces 212 and 222 of the holding unit 20 can eliminate room for expansion of the curved wall 141 of the container 100, and can restrict a dimensional change of the container 100.

Here, the BOL of the energy storage device 10 includes, for example, the time of shipment or the time immediately after manufacturing. The time immediately after manufacturing also includes a period in which a charge-discharge cycle after the energy storage device 10 is initially charged after the manufacturing falls within a predetermined number of times. The predetermined number of times is the number of times that the main body 710 of the electrode assembly 700 expands so that the outer surface of the main body 710 may come into contact with the inner surface of the container 100 as a whole. The predetermined number of times is preferably ten times, more preferably five times, and still more preferably three times.

The holding unit 20 holding the respective energy storage devices 10 is accommodated in the case 2 and then pressed in the Y-axis direction and the Z-axis direction by the case 2. At this time, as illustrated in FIG. 6, since the outer surface of the holding unit 20 and the inner surface of the case 2 are in surface contact with each other in the Y-axis direction and the Z-axis direction, not only a pressure (restraint force) by the holding unit 20 but also a pressure (restraint force) from the case 2 acts on the energy storage devices 10.

Whether or not the energy storage device 10 held by the holding unit 20 is pressed by the holding unit 20 can be determined by detecting deformation of the energy storage device 10 when the holding unit 20 and each of the energy storage devices 10 are disassembled. Specifically, a dimension of the energy storage device 10 before disassembly and a dimension of the energy storage device 10 after the disassembly are measured, and it can be determined that the energy storage device 10 is pressed before the disassembly when the dimension of the energy storage device 10 after the disassembly is larger than the dimension of the energy storage device 10 before the disassembly. Bulging of the energy storage device 10 may be determined based on a shape change before and after release of the pressing by imaging of CT or a shape change due to whether the energy storage device 10 is fitted into the holding unit 20 after the release of the pressing.

As described above, according to the energy storage device 10 of the present example embodiment of the present invention, the container 100 includes the curved wall 141 which faces the curved portion 711 of the electrode assembly 700, and the inner surface of the curved wall 141 has the curved shape along the curved portion 711 of the electrode assembly 700. Accordingly, a space formed between the curved portion 711 of the electrode assembly 700 and the curved wall 141 of the container 100 can be made smaller than a space formed between a curved portion of an electrode assembly and an inner surface of a container that is a prismatic container, and thus, it is possible to reduce or prevent a situation in which expansion of the curved portion 711 of the electrode assembly 700 relatively easily progresses with respect to expansion of the flat portion 712 of the electrode assembly 700. Further, the curved surfaces 212 and 222 each having the curved shape along the outer surface of the curved wall 141 of the container 100 are provided on the inner surface of the holding unit 20, and the electrode assembly 700 is pressed when the container 100 is pressed by the holding unit 20. Accordingly, the pressing from the holding unit 20 is transmitted to the electrode assembly 700 through the container 100, and the pressing force exceeding the strength of the container 100 can be applied to the electrode assembly 700, and the deformation of the container 100 due to the expansion of the electrode assembly 700 can be reduced or prevented. As a result, the tension generated at the boundary between the flat portion 712 and the curved portion 711 can be reduced or prevented, and the damage to the electrode assembly 700 can be reduced or prevented.

Since the inner surface of the curved wall 141 of the container 100 presses the curved portion 711 of the electrode assembly 700 and the inner surface of the flat wall 131 of the container 100 presses the flat portion 712 of the electrode assembly 700, both the curved portion 711 and the flat portion 712 of the electrode assembly 700 are pressed, and it is possible to more reliably reduce or prevent the situation in which the expansion of the curved portion 711 of the electrode assembly 700 relatively easily progresses with respect to the expansion of the flat portion 712 of the electrode assembly 700. As a result, the tension generated at the boundary between the flat portion 712 and the curved portion 711 can be further reduced or prevented, and the damage to the electrode assembly 700 can be further reduced or prevented.

A case where, immediately after manufacturing, the outer surface of the flat portion 712 of the electrode assembly 700 is not in contact with the inner surface of the flat wall 131 of the container 100 or the outer surface of the curved portion 711 of the electrode assembly 700 is not in contact with the inner surface of the curved wall 141 of the container 100 is conceivable. Even such a case is included in the configuration of the present application if the flat wall 131 of the container 100 presses the flat portion 712 of the electrode assembly 700 and the curved wall 141 of the container 100 presses the curved portion 711 of the electrode assembly 700 as the energy storage device 10 is used after sale or the like so that the electrode assembly 700 expands.

In a state where the flat portion 712 of the electrode assembly 700 is pressed by the flat wall 131 of the container 100 and the curved portion 711 of the electrode assembly 700 is pressed by the curved wall 141 of the container 100, the curved surfaces 212 and 213 of the holding unit 20 press the outer surface of the curved wall 141 of the container 100. That is, the pressing from the holding unit 20 is transmitted to the curved portion 711 of the electrode assembly 700 through the curved surfaces 212 and 213 of the holding unit 20 and the curved wall 141 of the container 100. Accordingly, a large pressing force exceeding the strength of the curved wall 141 of the container 1000 can be applied to the curved portion 711 of the electrode assembly 700, and the deformation of the container 100 due to the expansion of the curved portion 711 of the electrode assembly 700 can also be reduced or prevented.

Since the inner surface of the holding unit 20 presses the outer surface of the flat wall 131 of the container 100, the expansion of the flat wall 131 of the container 100 can be more reliably reduced or prevented. Further, the holding unit 20 presses the flat portion 712 of the electrode assembly 700 via the flat wall 131 of the container 100 and presses the curved portion 711 of the electrode assembly 700 via the curved wall 141 of the container 100, whereby the deformation of the entire electrode assembly 700 is reduced or prevented. Accordingly, it is possible to more reliably reduce or prevent a defect, such as a strain of the electrode assembly 700 generated at a stage earlier than the damage of the electrode assembly 700, which leads to a decrease in capacity.

Since each of the holding portions 21 integrally includes the flat surfaces 211 and 221 that press the flat wall 131 and the curved surfaces 212 and 222 that press the curved wall 141, both the expansion of the flat wall 131 and the expansion of the curved wall 141 in the container 100 can be reduced or prevented by the holding portion 21, and the electrode assembly 700 can be pressed with a simple configuration.

When the outer surface of the holding portion 21 is pressed against the case 2 (external structure), the curved surfaces 212 and 222 of the holding portion 21 press the outer surface of the curved wall 141 of the container 100. At this time, the curved surfaces 212 and 222 of the inner surface of the holding portion 21 themselves are also in the state of pressing the curved wall 141 of the container 100, and a large pressing force including both the pressing force from the case 2 and the pressing force from the holding portion 21 can be applied to the curved wall 141 of the container 100. Further, the deformation of the container 100 due to the expansion of the curved portion 711 of the electrode assembly 700 can be more reliably reduced or prevented. Since the electrode assembly 700 is also in the state of being pressed against the container 100, it is possible to more effectively reduce or prevent the expansion of the electrode assembly 700 from progressing beyond an internal dimension of the container 100. In addition, when the curved portion 711 of the electrode assembly 700 is pressed from the curved wall 141 of the container 100 and the flat portion 712 of the electrode assembly 700 is pressed from the flat wall 131 of the container 100, the expansion is reduced or prevented in both the curved portion 711 and the flat portion 712 of the electrode assembly 700, so that it is possible to reduce or prevent tensile stress therebetween from exceeding a current level, and foil breakage of the electrode assembly 700 is further reduced or prevented.

Here, it is preferable that the flat wall 131 of the container 100 is directly interposed between the flat surface 211 of the holding unit 20 and the flat portion 712 of the electrode assembly 700 to be brought into surface contact. It is preferable that the curved wall 141 of the container 100 is directly interposed between the curved surfaces 212 and 222 of the holding unit 20 and the curved portion 711 of the electrode assembly 700 to be brought into surface contact. Accordingly, the pressing force from the holding unit 20 is transmitted to the electrode assembly 700 through the walls (the flat wall 131 and the curved wall 141) of the container 100, and can press the electrode assembly 700.

### Comparison Between Present Invention and Conventional Technique

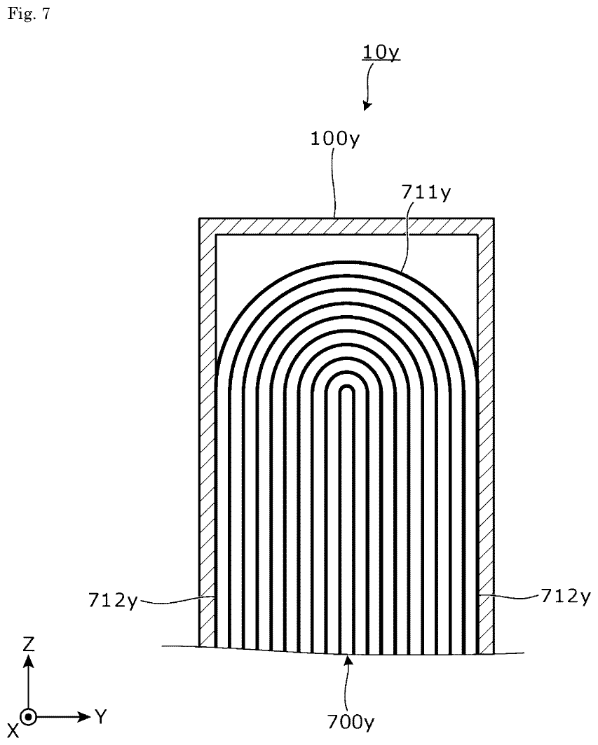

FIG. 7 is a cross-sectional view of an energy storage device 10y (Comparative Example 1) of a conventional technique taken along a plane parallel to the YZ plane. Specifically, the energy storage device 10y of Comparative Example 1 is the energy storage device 10y in which a flat winding-type electrode assembly 700y is accommodated in a prismatic container 100y. FIG. 7 illustrates an example of an internal structure of the energy storage device 10y in which an electrode assembly flat portion 712y and an inner surface of the container 100y are in contact with each other during expansion of the electrode assembly. In a conventional structure, depending on a design, there is a case where an electrode assembly curved portion 711y and the inner surface of the container 100y do not come into contact with each other even when the electrode assembly flat portion 712y and the inner surface of the container 100y come into contact with each other. As the expansion of the electrode assembly 700y progresses in such a case, in a region of the electrode assembly flat portion 712y, the expansion initially progresses mainly in a thickness direction (the Y-axis direction) of a plate, but the expansion gradually extends also in a longitudinal direction (the Z-axis direction) of the plate. Then, at the end of life of the energy storage device 10y, the expansion of the electrode assembly 700y in the thickness direction (the Y-axis direction) is pressed against the inner surface of the container 100y, and a frictional force between an inner surface of the energy storage device 10y and an outer surface of the electrode assembly flat portion 712y increases, so that extension in the longitudinal direction (the Z-axis direction) of the plate becomes impossible. On the other hand, in the electrode assembly curved portion 711y, even at the end of life of the energy storage device 10y, a surplus space between the electrode assembly 700y and the inner surface of the container 100y remains, and thus the extension in the longitudinal direction (the Y-axis direction and the Z-axis direction) of the plate is continued. Thus, strong tensile stress is generated in the plate in a region of a boundary between the electrode assembly flat portion 712y and the electrode assembly curved portion 711y of the electrode assembly 700y, and in the worst case, the plate may be broken.

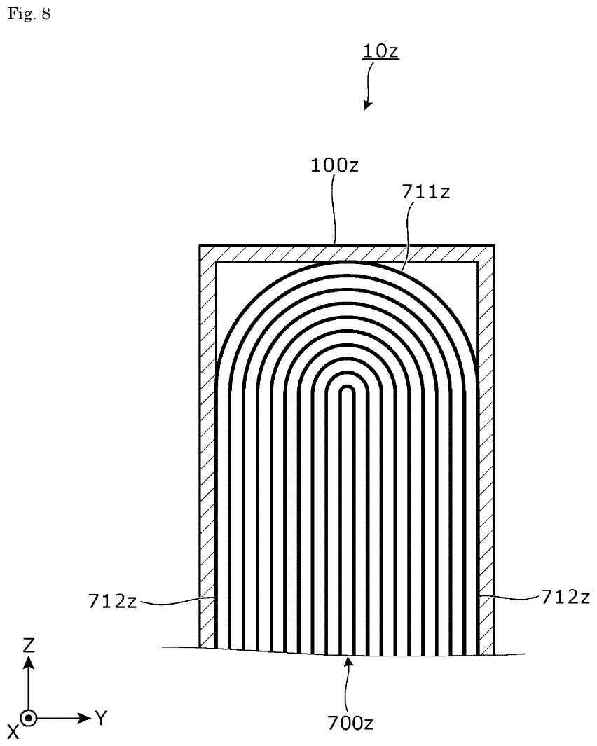

FIG. 8 is a cross-sectional view, taken along a plane parallel to the YZ plane, of an energy storage device 10z (Comparative Example 2) of a conventional technique obtained by partially changing the design of the energy storage device of Comparative Example 1. The energy storage device 10z of Comparative Example 2 illustrated in FIG. 8 is different from the energy storage device 10y of Comparative Example 1 in that, during expansion of an electrode assembly 700z, an upper portion (an end in the Z-axis plus direction) of an electrode assembly curved portion 711z and an electrode assembly flat portion 712z are brought into contact with an inner surface of a container 100z. The other configurations of the energy storage device 10z of Comparative Example 2 are the same as those of the energy storage device 10y of Comparative Example 1. In the case of the energy storage device 10y of Comparative Example 1, when the expansion of the electrode assembly 700y further progresses from the state illustrated in FIG. 7, the electrode assembly flat portion 712y of the electrode assembly 700y is pressed against the inner surface of the container 100y, and thus the extension in the longitudinal direction (Z-axis direction) of the plate becomes impossible. On the other hand, since the surplus space remains in the electrode assembly curved portion 711y, the extension in the longitudinal direction (the Y-axis direction and the Z-axis direction) of the plate is continued. On the other hand, in the energy storage device 10z of Comparative Example 2, the upper portion of the electrode assembly curved portion 711z (the end of the curved portion in the Z-axis direction) is also pressed against the inner surface of the container 100z, but a surplus space remains between the electrode assembly curved portion 711z and the inner surface of the container 100z except for the upper portion of the electrode assembly curved portion 711z. Thus, when deformation of the electrode assembly 700z occurs, there is a possibility that non-uniformity of the distance between electrodes occurs so that lithium electrodeposition occurs. This is likely to cause deterioration of battery capacity.

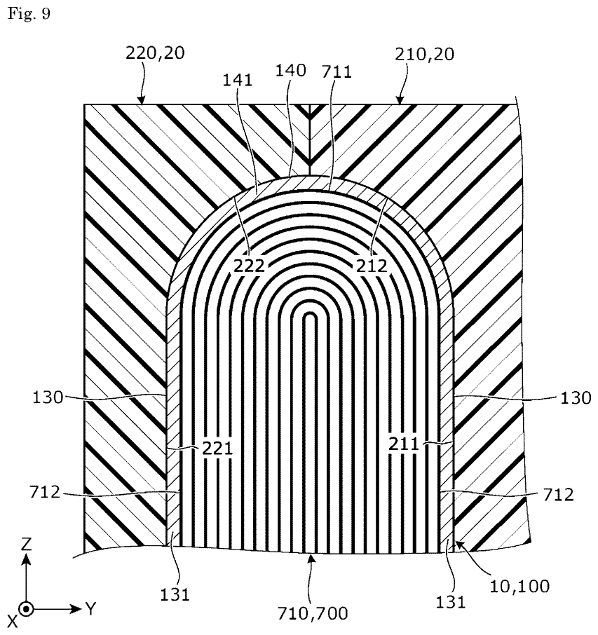

FIG. 9 illustrates an example of the energy storage apparatus 1 having a structure in which the curved surface 222 of the holding unit 20 of the present invention presses the outer surface of the curved wall 141 of the container 100 of the energy storage device 10. The electrode assembly 700 including the curved portion 711 and the flat portion 712 is housed in the container 100 disposed along the outer surface of the electrode assembly 700, and the holding unit 20 is disposed along the outer surface of the container 100. In FIG. 9, as the holding unit 20, the intermediate spacer 210 and the end spacer 220, which are two holding portions, press the energy storage device 10. In this manner, the holding unit 20 presses the container 100 of the energy storage device 10 and the electrode assembly 700. In the present invention, when the expansion of the electrode assembly 700 progresses, the entire container 100 and the entire holding unit 20 uniformly press the expansion of the electrode assembly 700. Thus, it is possible to reduce or prevent the occurrence of the deformation of the electrode assembly and breakage of the electrode due to generation of the tensile stress between the curved portion 711 and the flat portion 712 as described above.

Hereinafter, each modification example of the above example embodiment will be described. In the following description, the same portions as those in the above example embodiment or other modification examples may be denoted by the same reference signs, and the description thereof may be omitted.

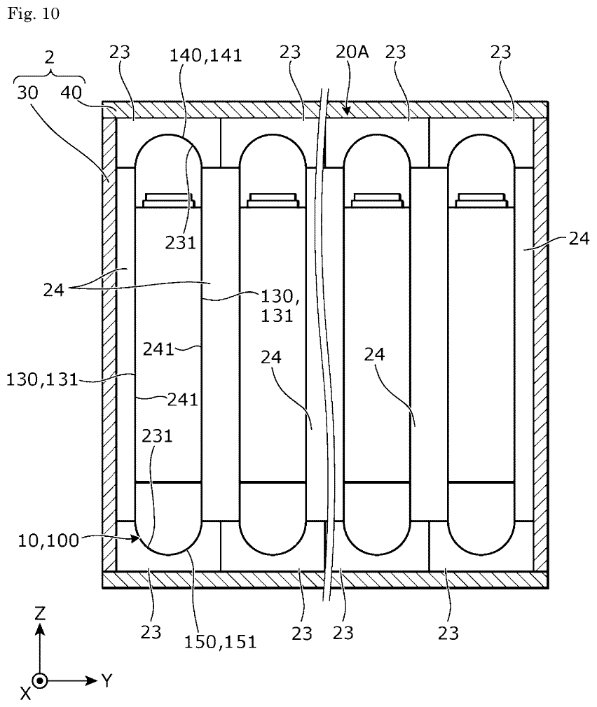

A holding unit 20A according to a first modification example of an example embodiment of the present invention will be described. FIG. 10 is an explanatory view illustrating the holding unit 20A, the case 2, and the energy storage devices 10 according to the first modification example.

As illustrated in FIG. 10, the holding unit 20A includes a plurality of first holding portions 23 and a plurality of second holding portions 24 for the energy storage devices 10. The first holding portion 23 and the second holding portion 24 are separate members.

Among the plurality of first holding portions 23, a pair of first holding portions 23 in the Z-axis direction is disposed at positions sandwiching the container 100 of the energy storage device 10 in the Z-axis direction. The first holding portion 23 has an outer shape having, as a reference, a rectangular parallelepiped shape elongated in the X-axis direction. A lower surface (a surface facing the Z-axis minus direction) of the first holding portion 23 located in the Z-axis plus direction has a shape recessed in the Z-axis plus direction along an outer shape of the energy storage device 10. This recessed portion is recessed most at the center of the lower surface of the first holding portion 23 in the Y-axis direction, and has a U shape as viewed in the X-axis direction. Further, the recessed portion has a curved shape along an outer surface of the curved wall 141. In a mode of the first modification example, since a thickness of the curved wall 141 is constant, the recessed portion also has a curved shape along an inner surface of the curved wall 141. The recessed portion includes a curved surface 231, and the curved surface 231 is brought into surface contact with the outer surface of the curved wall 141 of the energy storage device 10.

Similarly, an upper surface (a surface facing the Z-axis plus direction) of the first holding portion 23 located in the Z-axis minus direction has a shape recessed in the Z-axis minus direction along the outer shape of the adjacent energy storage device 10. This recessed portion has a U shape as viewed in the X-axis direction. The recessed portion has a curved shape along an outer surface of the curved wall 151. In a mode of the first modification example, since a thickness of the curved wall 151 is constant, the recessed portion also has a curved shape along an inner surface of the curved wall 151. The recessed portion is the curved surface 231 which is brought into surface contact with the outer surface of the curved wall 151 of the energy storage device 10.

Each of the plurality of second holding portions 24 is disposed alternately with each of the energy storage devices 10 in the Y-axis direction. The second holding portion 24 has a flat plate shape that is elongated in the X-axis direction, parallel to the XZ plane, and flat in the Y-axis direction. A surface of the second holding portion 24 in the Z-axis plus direction is in contact with a lower surface (a surface facing the Z-axis minus direction) of the first holding portion 23 located in the Z-axis plus direction with respect to the second holding portion 24, and a surface of the second holding portion 24 in the Z-axis minus direction is in contact with an upper surface (a surface facing the Z-axis plus direction) of the first holding portion 23 located in the Z-axis minus direction with respect to the second holding portion 24. A surface, which faces the energy storage device 10 in the Y-axis direction, of each of the second holding portions 24 is a flat surface 241 that comes into surface contact with the outer surface of the flat wall 131 of the energy storage device 10.

As described above, since the first holding portion 23 and the second holding portion 24 are separate members, it is not necessary to simultaneously install the first holding portion 23 and the second holding portion 24, and it is easy to manufacture the energy storage apparatus 1. Furthermore, a pressing force applied from the first holding portion 23 to a facing direction of the pair of curved portions 711 of the electrode assembly 700 and a pressing force applied from the second holding portion 24 to a direction perpendicular to the flat portion 712 of the electrode assembly 700 can be individually adjusted. Even when a size of the energy storage device 10 is changed due to a design change or a model change, if a shape of the container 100 is partially the same, either one of the first holding portion 23 and the second holding portion 24 can be diverted to reduce a manufacturing cost.

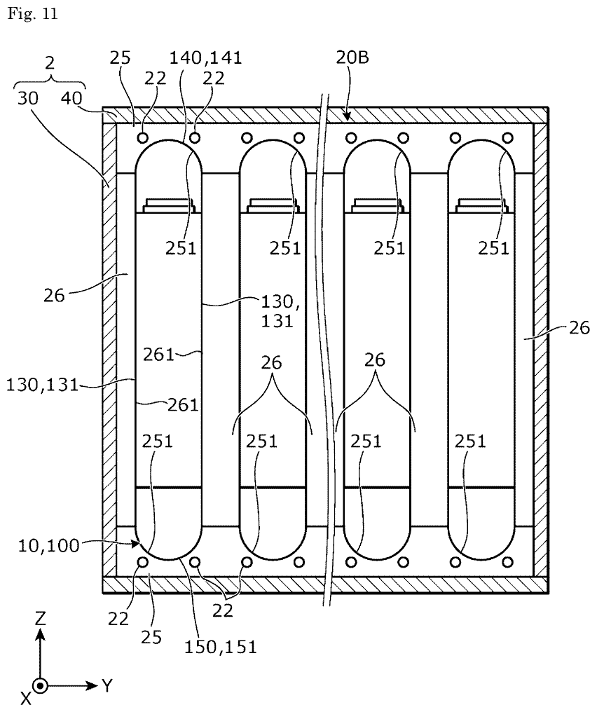

A holding unit 20B according to the second modification example of an example embodiment of the present invention will be described. FIG. 11 is an explanatory view illustrating the holding unit 20B, the case 2, and the energy storage devices 10 according to the second modification example.

As illustrated in FIG. 11, the holding unit 20B includes a pair of first holding portions 25 and a plurality of second holding portions 26. The first holding portion 25 and the second holding portion 26 are separate members, that is, members different from each other. In this modification example, a case where the first holding portion 25 includes a refrigerant passage 22 through which a refrigerant flows is exemplified, but a passage through which a medium flows for the purpose of temperature adjustment of the energy storage device may be provided. That is, the refrigerant passage 22 may be the passage through which the medium for retaining heat of or heating the energy storage device flows.

Each of the plurality of second holding portions 26 is disposed alternately with each of the energy storage devices 10 in the Y-axis direction. Each of the second holding portions 26 has a flat plate shape that is elongated in the X-axis direction, parallel to the XZ plane, and flat in the Y-axis direction. Each surface, which faces the Y-axis direction, of each of the second holding portions 26 is a planar flat surface 261 which faces the outer surface of the flat wall 131 of the energy storage device 10 and comes into contact with the outer surface of the flat wall 131 of the energy storage device 10.

The pair of first holding portions 25 is disposed at positions sandwiching the container 100 of the energy storage device 10 and the plurality of second holding portions 26 in the Z-axis direction. The first holding portion 25 has an outer shape having, as a reference, a rectangular parallelepiped shape elongated in the X-axis direction and flat in the Z-axis direction. A place facing each of the energy storage devices 10 in the Z-axis direction on a surface facing the Z-axis minus direction of the first holding portion 25 located in the Z-axis plus direction has a shape recessed in the Z-axis plus direction along the outer shape of the energy storage device 10. The number of such recessed portions is equal to the number of the energy storage devices 10 to be installed. Each of the recessed portions has a U shape as viewed in the X-axis direction. The recessed portion has a curved shape along the outer surface of the curved wall 141. In a mode of the present modification example, since a thickness of the curved wall 141 is constant, the recessed portion also has a curved shape along the inner surface of the curved wall 141. Each of the recessed portions is a curved surface 251 which is brought into surface contact with the outer surface of the curved wall 141 of the energy storage device 10.

Similarly, a place facing each of the energy storage devices 10 in the Z-axis direction on a surface facing the Z-axis plus direction of the first holding portion 25 located in the Z-axis minus direction has a shape recessed in the Z-axis minus direction along the outer shape of the energy storage device 10. The number of such recessed portions is equal to the number of the energy storage devices 10 to be installed. Each of the recessed portions has a U shape as viewed in the X-axis direction. The recessed portion has a curved shape along the outer surface of the curved wall 141. In a mode of the present modification example, since a thickness of the curved wall 141 is constant, the recessed portion also has a curved shape along the inner surface of the curved wall 141. Each of the recessed portions is a curved surface 251 which is brought into surface contact with the outer surface of the curved wall 141 of the energy storage device 10. As described above, each of the first holding portions 25 integrally includes the plurality of curved surfaces 251.

In the plurality of energy storage devices 10 held by the holding unit 20B, one energy storage device 10 is an example of a first energy storage device, and another energy storage device 10 adjacent to the first energy storage device in the Y-axis direction is an example of a second energy storage device. The electrode assembly 700 included in the first energy storage device is an example of a first electrode assembly. The flat portion 712 and the curved portion 711 included in the first electrode assembly are examples of a first flat portion and a first curved portion. The container 100 included in the first energy storage device is an example of a first container. The flat wall 131 and the curved wall 141 included in the first container are examples of a first flat wall and a first curved wall. The electrode assembly 700 included in the second energy storage device is an example of a second electrode assembly. The flat portion 712 and the curved portion 711 included in the second electrode assembly are examples of a second flat portion and a second curved portion. The container 100 included in the second energy storage device is an example of a second container. The flat wall 131 and the curved wall 141 included in the second container are examples of a second flat wall and a second curved wall. Among the plurality of curved surfaces 251 of the first holding portions 25, the curved surface 251 facing the curved wall 141 of the first energy storage device and the curved surface 251 facing the curved wall 151 of the first energy storage device are examples of a first curved surface, and the curved surface 251 facing the curved wall 141 of the second energy storage device and the curved surface 251 facing the curved wall 151 of the second energy storage device are examples of a second curved surface.

As described above, since the plurality of curved surfaces 251 (the first curved surface and the second curved surface) of the first holding portion 25 face the curved walls 141 and 151 of the plurality of energy storage devices 10 (the first energy storage device and the second energy storage device), the plurality of curved surfaces 251 of the first holding portion 25 can collectively press the plurality of curved walls 141 and 151. Furthermore, the number of the first holding portions 25 may be smaller than that in a case where one first holding portion is disposed for one curved wall, and thus the assembly of the energy storage apparatus 1 is facilitated.

Since the first holding portion 25 is made of a foamed resin, it is easy to form the curved surface 251 of the first holding portion 25 along the shapes of the curved walls 141 and 151 of the container 100 at the time of manufacturing. The number of components related to the first holding portion 25 can be reduced, and the manufacturing is easy. The first holding portion 25 is formed using a material having sufficient strength even with the foamed resin and having an elastic region sufficient for reducing or preventing the expansion of the electrode assembly 700. Examples of such a foamed resin include a urethane glass resin. Note that a portion of the holding unit 20B other than the first holding portion 25 may be formed using the foamed resin.

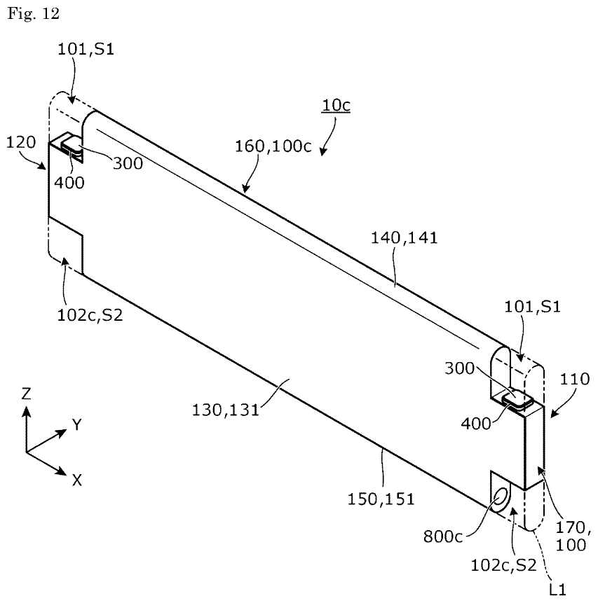

An energy storage device 10c according to a third modification example will be described. FIG. 12 is a perspective view illustrating an appearance of the energy storage device 10c according to the third modification example. As illustrated in FIG. 12, in a container 100c of the energy storage device 10c, a gas release valve 800c is disposed on a surface parallel to the YZ plane in each of second recesses 102c. In this case, the gas release valve is not provided on a surface parallel to the XY plane in each of the second recesses 102c. The gas release valve 800c may be provided only in one second recess 102c. The gas release valve may be provided in at least one first recess.

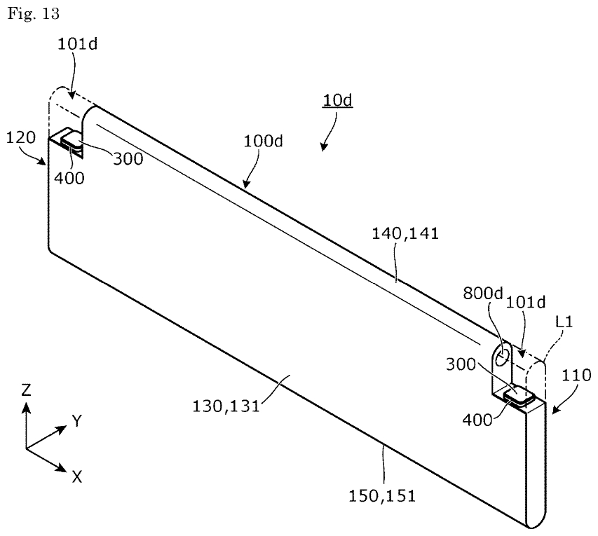

An energy storage device 10d according to a fourth modification example of an example embodiment of the present invention will be described. FIG. 13 is a perspective view illustrating an appearance of the energy storage device 10d according to the fourth modification example. As illustrated in FIG. 13, a container 100d of the energy storage device 10d has a pair of first recesses 101d at positions in the Z-axis plus direction, but has no recess at a position in the Z-axis minus direction of the container 100d. At least one first recess 101d in the container 100d is provided with a gas release valve 800d on a surface parallel to the YZ plane.

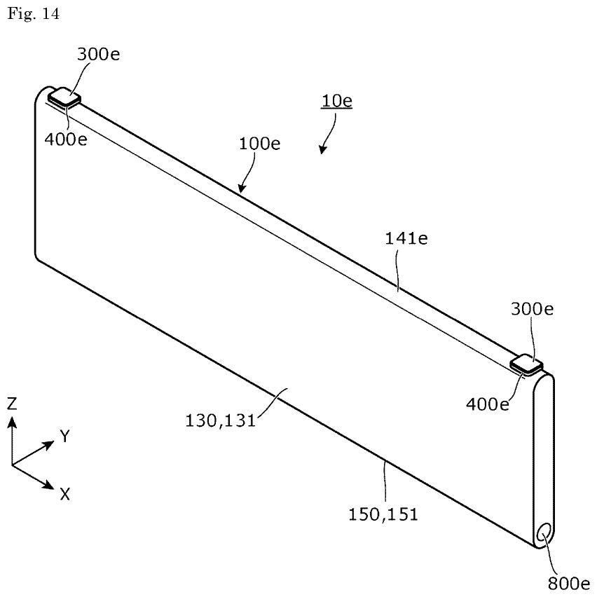

An energy storage device 10e according to a fifth modification example of an example embodiment of the present invention will be described. FIG. 14 is a perspective view illustrating an appearance of the energy storage device 10e according to the fifth modification example. As illustrated in FIG. 14, a container 100e of the energy storage device 10e does not include a recess, and has an outer shape that is elongated in the X-axis direction and formed in an elongated cylindrical shape as a whole. Each of terminals 300e and each of outer gaskets 400e are disposed on an outer surface of a curved wall 141e of the container 100e, and each of the terminals 300e protrudes in the Z-axis plus direction from the outer surface of the curved wall 141e of the container 100e. At least one of a pair of end surfaces of the container 100e in the X-axis direction is provided with a gas release valve 800e.

As described above, since each of the terminals 300e protrudes from the outer surface of the curved wall 141e of the container 100e, the internal space of the container 100e is hardly consumed. Accordingly, the electrode assembly 700 can be formed as large as possible, and thus the energy density can be increased.

Further, since each of the terminals 300e protrudes from the outer surface of the curved wall 141e of the container 100e, it is possible to easily perform connection work with the terminal 300e of another energy storage device 10e.

In a mode of the energy storage device 10e according to the fifth modification example, since the terminal 300e is not provided on a surface of the container 100e in the winding-axis direction (X-axis direction), when the energy storage device 10e is accommodated in the case 2, a protective member and the like to be disposed at an end position in the winding-axis direction with respect to the energy storage device 10e can be simplified and downsized. Further, the degree of freedom in designing the case 2 can be increased as compared with an energy storage device including a terminal on a surface in the winding-axis direction.

A space sandwiched between the holding unit 20 and the wall of the case 2 is provided at a position in the Z-axis plus direction with respect to the terminal 300, and the energy density of the entire energy storage apparatus can be improved by disposing a bus bar or the like in the space.

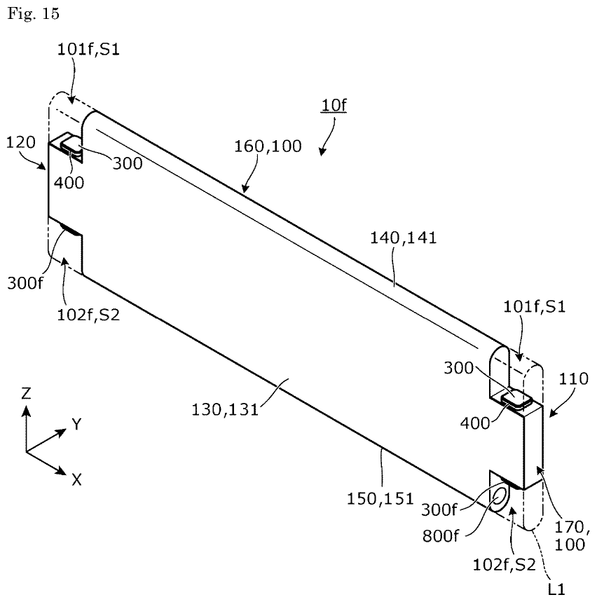

An energy storage device 10f according to a sixth modification example of an example embodiment of the present invention will be described. FIG. 15 is a perspective view illustrating an appearance of the energy storage device 10f according to the sixth modification example. As illustrated in FIG. 15, in the energy storage device 10f, the terminal 300 and an outer gasket (not illustrated) are disposed on a surface parallel to the XY plane in each of second recesses 102f. That is, one energy storage device 10f includes four terminals 300. A gas release valve 800f is disposed on a surface parallel to the YZ plane in the second recess 102f, but may be disposed on a surface parallel to the YZ plane in the first recess 101f.

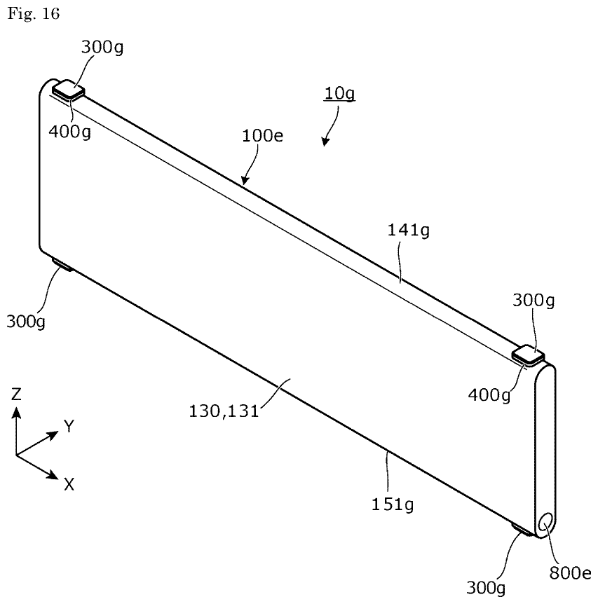

An energy storage device 10g according to a seventh modification example of an example embodiment of the present invention will be described. FIG. 16 is a perspective view illustrating an appearance of the energy storage device 10g according to the seventh modification example. In the energy storage device 10e according to the fifth modification example, the terminals 300e and outer gaskets (not illustrated) are disposed at both ends in the X-axis direction of the curved wall 141e. However, in the energy storage device 10g according to the seventh modification example, terminals 300g and outer gaskets 400g are disposed at both ends in the X-axis direction of a curved wall 141g and at both ends in the X-axis direction of a curved wall 151g. That is, one energy storage device 10g includes four terminals 300.

As described above, the energy storage devices according to the example embodiments (including modification examples thereof, the same applies hereinafter) of the present invention has been described, but the present invention is not limited to the above example embodiments. The example embodiments disclosed herein are merely non-limiting examples in all respects, and the scope of the present invention includes all changes within the meaning and scope equivalent to the claims.

Although not illustrated in the above example embodiments, it is sufficient to adopt a configuration in which a pressing force from a curved surface of a holding unit is transmitted to a curved wall of a container, and a case where a curved shape of an outer surface of the curved wall of the container is replaced with a substantially circular polyhedral shape is also included in example embodiments of the present invention, and a case where a curved shape of the curved surface of the holding unit is replaced with a polyhedral shape is also included in example embodiments of the present invention. At least one of the outer surface of the curved wall of the container and the curved surface of the holding unit may have a curved shape having a curvature different from that of an inner surface of the curved wall and/or a shape having one or more corners and/or one or more planes. For example, at least one of the outer surface of the curved wall of the container and the curved surface of the holding unit may be a polyhedron.

Although not illustrated in the above example embodiments, in a holding unit, a portion of the holding unit other than the first holding portions 23 and 25 may be formed using a foamed resin. Note that various methods of forming the holding unit with the foamed resin are conceivable. The holding unit may be formed by disposing the energy storage device in the energy storage apparatus and then injecting and solidifying the foamed resin, or a member forming the holding unit molded in advance may be assembled together with the energy storage device and the like. The holding unit may include a combination of a portion filled with the foamed resin and then solidified inside the energy storage apparatus and a portion that is molded in advance before the assembly of the energy storage apparatus. In this case, a step of filling a portion of the holding unit with the foamed resin in the energy storage apparatus and solidifying the foamed resin, and a step of assembling a portion of the holding unit molded in advance in the energy storage apparatus may be performed in any order without being particularly limited. For example, after the energy storage device and a first holding portion (a portion of the holding unit) which faces a curved wall of the energy storage device are positioned and disposed in the energy storage apparatus, a second holding portion (a portion of the holding unit) which faces a flat wall of the energy storage device may be formed by injecting the foamed resin. Note that, in this example, the first holding portion (a portion of the holding unit) molded in advance with a fixed shape is disposed in the energy storage apparatus together with the energy storage device. Furthermore, a material of the first holding portion (a portion of the holding unit) which is molded in advance before the assembly of the energy storage apparatus may be the foamed resin or a material different from the foamed resin. Alternatively, the holding unit may be formed by positioning and disposing the energy storage device and then injecting and solidifying the foamed resin once or a plurality of times. portions, which are molded in advance with fixed shapes, of the holding unit may be assembled together with the energy storage device.

Although the energy storage apparatuses 1 in each of which the plurality of energy storage devices 10 is accommodated in the case 2 have been exemplified in the above example embodiments, it is sufficient for the energy storage apparatus to include one or more energy storage devices accommodated in the case.

In the above example embodiments, the case where the external structure is the box-shaped case 2 has been exemplified. The external structure may be formed by aluminum die casting. Furthermore, the external structure may be a member constituting a moving body itself such as an automobile. Examples of the moving body itself include a skeleton structure of the moving body, a carriage, a chassis, and the like.

Although a case of the packed energy storage apparatus 1 in which the energy storage devices 10 and the holding units 20 are accommodated in the case 2 has been exemplified in the above example embodiments, the energy storage apparatus may be a modular energy storage apparatus.

Example embodiments constructed by freely combining the elements included in the above example embodiments and the modification examples thereof are also included in the scope of the present invention.

Example embodiments of the present invention can be applied to energy storage devices such as lithium ion secondary batteries and energy storage apparatuses including the same.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
an energy storage device; and
a holding unit located outward of the energy storage device to hold the energy storage device; wherein
the energy storage device includes:
an electrode assembly around which a plate is wound; and
a container which accommodates the electrode assembly;
the electrode assembly has a flat shape including a pair of flat portions facing each other and a pair of curved portions facing each other;
the container includes:
a flat wall facing the flat portion of the electrode assembly; and
a curved wall facing the curved portion of the electrode assembly;
an inner surface of the flat wall has a flat shape along the flat portion;
an inner surface of the curved wall has a curved shape along the curved portion;
an inner surface of the holding unit includes:
a flat surface having a flat shape along an outer surface of the flat wall of the container; and
a curved surface having a curved shape along an outer surface of the curved wall of the container;
the inner surface of the flat wall of the container presses the flat portion of the electrode assembly;
the inner surface of the curved wall of the container presses the curved portion of the electrode assembly;
the flat surface of the holding unit presses the outer surface of the flat wall of the container; and
the curved surface of the holding unit presses the outer surface of the curved wall of the container.

2. The energy storage apparatus according to claim 1, further comprising an external structure or a case located outward of the holding unit to fix or accommodate the holding unit; and
an outer surface of the holding unit is pressed by the external structure or the case to make the curved surface of the holding unit press the outer surface of the curved wall of the container of the energy storage device and to make the flat surface of the holding unit press the outer surface of the flat wall of the container of the energy storage device.

3. The energy storage apparatus according to claim 2, wherein
the holding unit includes a plurality of holding portions arranged in a direction in which the flat portion of the electrode assembly and the flat wall of the container face each other, and
an inner surface of the holding portion includes the flat surface which presses the outer surface of the flat wall of the container, and the curved surface which presses the outer surface of the curved wall of the container.

4. The energy storage apparatus according to claim 2, wherein the holding unit includes:
a pair of first holding portions sandwiching the energy storage device in a direction in which the curved portion of the electrode assembly and the curved wall of the container face each other; and
a pair of second holding portions sandwiching the energy storage device in a direction in which the flat portion and the flat wall face each other;
the pair of first holding portions include structures separate from the pair of second holding portions;
an inner surface of the first holding portion includes the curved surface which presses the curved wall of the container; and
an inner surface of the second holding portion includes the flat surface which presses the flat wall of the container.

5. The energy storage apparatus according to claim 4, comprising a plurality of the energy storage devices including a first energy storage device and a second energy storage device;
the first energy storage device includes:
a first electrode assembly having a configuration identical to a configuration of the electrode assembly; and
a first container having a configuration identical to a configuration of the container;
the first electrode assembly has a flat shape including a first flat portion having a configuration identical to a configuration of the flat portion and a first curved portion having a configuration identical to a configuration of the curved portion;
the first container includes a first flat wall having a configuration identical to a configuration of the flat wall and a first curved wall having a configuration identical to a configuration of the curved wall;
the second energy storage device includes:
a second electrode assembly having a configuration identical to the configuration of the electrode assembly; and
a second container having a configuration identical to the configuration of the container;
the second electrode assembly has a flat shape including a second flat portion having a configuration identical to the configuration of the flat portion and a second curved portion having a configuration identical to the configuration of the curved portion;
the second container includes a second flat wall having a configuration identical to the configuration of the flat wall and a second curved wall having a configuration identical to the configuration of the curved wall;
a surface of the first flat wall included in the first container of the first energy storage device and a surface of the second flat wall included in the second container of the second energy storage device face each other;
an inner surface of the first holding portion includes a plurality of the curved surfaces integrated with each other;
the plurality of curved surfaces includes a first curved surface facing the first curved wall and a second curved surface facing the second curved wall;
an outer surface of the first curved wall in the first container is pressed by the first curved surface of the first holding portion to cause a state in which the first curved portion of the first electrode assembly is pressed; and
an outer surface of the second curved wall in the second container is pressed by the second curved surface of the first holding portion to cause a state in which the second curved portion of the second electrode assembly is pressed.

6. The energy storage apparatus according to claim 1, wherein the holding unit includes a foamed resin.

7. The energy storage apparatus according to claim 1, wherein the holding unit includes a refrigerant passage through which a refrigerant flows.
